(19) United States
(12) Patent Application Publication
(10) Pub. No.: US 2015/0081466 A1
(43) Pub. Date: Mar. 19, 2015

(54) NOTIFICATION CONTROL SYSTEM, NOTIFICATION CONTROL DEVICE, NOTIFICATION CONTROL METHOD, AND PROGRAM

(71) Applicant: Rakuten, Inc., Tokyo (JP)

(72) Inventor: Yusuke Sakurai, Tokyo (JP)

(21) Appl. No.: 14/381,993

(22) PCT Filed: Aug. 5, 2013
(86) PCT No.: PCT/JP2013/071168

§ 371 Date: Aug. 29, 2014

(30) Foreign Application Priority Data
Nov. 30, 2012 (JP) 2012-262268

(51) Int. Cl. G06Q 30/06; G06Q 10/08

(52) U.S. Cl. CPC G06Q 30/0601; G06Q 10/087
USPC 705/26.1

(57) ABSTRACT

To reduce bothers related to back-in-stock notification of an item. Arrival notice request receiving means of a notification control system receives from a user a request for an arrival notice of an item. In a case where the item arrives, arrival notifying means notifies the arrival to the user whose arrival notice request has been received. Stock determining means determines whether or not the item is in stock in the case where the user whose arrival notice request has been received accesses an item page of the item after the item arrives. Back-in-stock notification control means controls back-in-stock notification of the item to the user whose arrival notice request has been received, based on the result of the determination by the stock determining means.

### TECHNICAL FIELD

The present invention relates to a notification control system, a notification control device, a notification control method, and a program.

### BACKGROUND ART

Hitherto, there has been known a technology for notifying a user of the arrival of merchandise at the time the merchandise arrives. In Patent Literature 1, there is disclosed a technology for transmitting, in a system for providing an Internet shopping service, an arrival notice upon arrival of an item to a user who has requested for the arrival notice of the item.

### CITATION LIST

### Patent Literature

[PTL 1] JP 2003-30507 A

### SUMMARY OF INVENTION

### Technical Problems

With the above-mentioned technology or a similar technology, there is a chance that, soon after an item arrives and its arrival notice is sent, the item sells out and becomes out of stock again. Accordingly, the item may still be in stock or have already gone out of stock depending on when a notified user accesses the item's page.

In the case where the item has already gone out of stock at the time a user accesses the item's page, for example, the user cannot purchase the item and the need to send a back-in-stock notice, which is for notifying that the item is back in stock, is high. With the existing technologies, however, a user who wishes to receive a back-in-stock notice needs to request for an arrival notice again and would feel the process as a bother.

A possible solution is to send a back-in-stock notice automatically each time the item comes back in stock to a user once the user makes an arrival notice request. However, in the case where the item is still in stock at the time the user accesses the item's page, the user can purchase the item and there is not much need to send a back-in-stock notice. The back-in-stock notice in this case is sent to the user repeatedly over an indefinite period of time unless, for example, the user requests that the sending of the back-in-stock notice be stopped, which is again a bother to the user.

The present invention has been made in view of the problems described above, and an object of the present invention is to provide a notification control system, a notification control device, a notification control method, and a program which are capable of reducing bothers related to back-in-stock notification of an item.

### Solution to Problems

In order to attain the above-mentioned object, a notification control system according to one embodiment of the present invention includes: means for obtaining what is stored in means for storing data about an inventory of an item; arrival notice request receiving means for receiving from a user a request for an arrival notice of the item; arrival notifying means for notifying, when the item arrives, the arrival of the item to the user whose arrival notice request has been received; stock determining means for determining whether or not the item is in stock when the user whose arrival notice request has been received accesses an item page of the item after the item arrives; and back-in-stock notification control means for controlling a back-in-stock notification of the item to the user whose arrival notice request has been received, based on a result of the determination by the stock determining means.

Further, a notification control device according to one embodiment of the present invention includes: means for obtaining what is stored in means for storing data about an inventory of an item; arrival notice request receiving means for receiving from a user a request for an arrival notice of the item; arrival notifying means for notifying, when the item arrives, the arrival of the item to the user whose arrival notice request has been received; stock determining means for determining whether or not the item is in stock when the user whose arrival notice request has been received accesses an item page of the item after the item arrives; and back-in-stock notification control means for controlling a back-in-stock notification of the item to the user whose arrival notice request has been received, based on a result of the determination by the stock determining means.

Further, a notification control method according to one embodiment of the present invention includes: a step of obtaining what is stored in means for storing data about an inventory of an item; an arrival notice request receiving step of receiving from a user a request for an arrival notice of the item; an arrival notifying step of notifying, when the item arrives, the arrival of the item to the user whose arrival notice request has been received; a stock determining step of determining whether or not the item is in stock when the user whose arrival notice request has been received accesses an item page of the item after the item arrives; and a back-in-stock notification control step of controlling a back-in-stock notification of the item to the user whose arrival notice request has been received, based on a result of the determination in the stock determining step.

Further, a program according to one embodiment of the present invention causes a computer to function as: means for obtaining what is stored in means for storing data about an inventory of an item; arrival notice request receiving means for receiving from a user a request for an arrival notice of the item; arrival notifying means for notifying, when the item arrives, the arrival of the item to the user whose arrival notice request has been received; stock determining means for determining whether or not the item is in stock when the user whose arrival notice request has been received accesses an item page of the item after the item arrives; and back-in-stock notification control means for controlling a back-in-stock notification of the item to the user whose arrival notice request has been received, based on a result of the determination by the stock determining means.

Further, an information recording medium according to one embodiment of the present invention is a computer-readable information recording medium having the above-mentioned program recorded thereon.

Further, in an aspect of the present invention: the arrival notifying means performs arrival notification to the user whose arrival notice request has been received, based on identification information for identifying whether or not the user is to be notified of the arrival of the item; the arrival notice request receiving means sets, when receiving the arrival notice request, the identification information so that the user whose arrival notice request is received is notified of the arrival of the item; the arrival notifying means sets, once notifying the arrival of the item to the user whose arrival notice request has been received, the identification information so that the user is prevented from being notified in the future in the event that the item comes back in stock; and the back-in-stock notification control means sets, when the stock determining means determines that the item is out of stock, the identification information so that the user whose arrival notice request has been received is notified in the future in the event that the item comes back in stock.

Further, in an aspect of the present invention, the notification control system further includes: means for receiving from the user a stop request, which is a request to stop the arrival notice; and means for determining whether or not the stop request has been received from the user whose arrival notice request has previously been received, and the arrival notifying means maintains back-in-stock notification to the user whose arrival notice request has been received over a period from the reception of the arrival notice request to the reception of the stop request, and, when the stock determining means determines that the item is in stock, the back-in-stock notification control means controls the arrival notifying means so that the arrival notifying means stops notifying, in the future, that the item is back in stock to the user whose arrival notice request has been received.

Further, in an aspect of the present invention, the notification control system further includes purchase determining means for determining whether or not the user whose arrival notice request has been received has purchased the item after the reception of the arrival notice request, and the back-in-stock notification control means controls back-in-stock notification to the user whose arrival notice request has been received based on a result of the determination by the purchase determining means and the result of the determination by the stock determining means.

Further, in an aspect of the present invention, the notification control system further includes interval determining means for determining whether or not an interval between a time point related to the arrival of the item and a time when the user whose arrival notice request has been received accesses the item page is equal to or more than a reference interval, and the back-in-stock notification control means controls back-in-stock notification to the user whose arrival notice request has been received based on a result of the determination by the interval determining means and the result of the determination by the stock determining means.

Further, in an aspect of the present invention: the item page includes information about a plurality of items; the notification control system further includes display determining means for determining whether or not a portion of the item page that shows an item for which the arrival notice request has been made has been displayed on display means operated by the user whose arrival notice request has been received; and the back-in-stock notification control means controls back-in-stock notification to the user whose arrival notice request has been received based on a result of the determination by the display determining means and the result of the determination by the stock determining means.

Further, in an aspect of the present invention: the arrival notice request receiving means receives the arrival notice request when the user whose arrival notice request is received selects a given indicator included in the item page; and the notification control system further includes means for disabling the selecting of the given indicator on the item page when the user whose arrival notice request has been received is to be notified that the item is back in stock.

Further, in an aspect of the present invention, the notification control system further includes: out-of-stock notifying means for notifying the user whose arrival notice request has been received that the item is out of stock when the item arrives and then goes out of stock again; and access determining means for determining whether or not the user whose arrival notice request has been received has accessed the item page in response to the out-of-stock notification, and the back-in-stock notification control means controls back-in-stock notification to the user whose arrival notice request has been received based on a result of the determination by the access determining means and the result of the determination by the stock determining means.

Further, in an aspect of the present invention, the out-of-stock notifying means performs the out-of-stock notification when the user whose arrival notice request has been received is yet to access the item page during a period from the notification of the arrival to the item's going out of stock again.

Further, in an aspect of the present invention, the notification control system further includes item suggesting means for suggesting, when the arrival notice request is received, the same item as the item for which the arrival notice request is made, or a second item similar to the item of the arrival notice request, to the user whose arrival notice request is received.

Further, in an aspect of the present invention: the item of the arrival notice request is the same as or similar to a plurality of other items; and the item suggesting means suggests, to the user whose arrival notice request has been received, one of the plurality of other items that is advantageous in purchase conditions over the item of the arrival notice request.

Further, in an aspect of the present invention, the notification control system further includes means for suggesting cancellation of the arrival notice request to the user whose arrival notice request has been received when the item suggesting means suggests the second item.

Further, in an aspect of the present invention, the notification control system further includes means for obtaining a specified count of pieces of the item, which is specified by the user whose arrival notice request is received, and the stock determining means determines whether or not the item is in stock based on the current in-stock count of the item and the specified count specified by the user whose arrival notice request is received.

### Advantageous Effects of Invention

According to one embodiment of the present invention, it is possible to reduce the bothers related to the back-in-stock notification of the item.

### BRIEF DESCRIPTION OF DRAWINGS

FIG. 1 is a diagram illustrating an example of the overall configuration of an online shopping system according to embodiments of the present invention.

FIG. 2 is a hardware configuration diagram of a sales management server.

FIG. 3 is a hardware configuration diagram of a user terminal.

FIG. 4 is a diagram illustrating a screen example of an item page.

FIG. 5 is a diagram illustrating a screen example of an item page that is displayed when an item is out of stock.

FIG. 6 is a diagram illustrating an example of an arrival notice mail.

FIG. 7 is a function block diagram illustrating functions that are implemented in the online shopping system.

FIG. 8 is a table showing a data storage example of inventory data.

FIG. 9 is a table showing a data storage example of user data.

FIG. 10 is a table showing a data storage example of arrival notification data.

FIG. 11 is a diagram illustrating processing that is executed in the online shopping system.

FIG. 12 is a diagram illustrating processing that is executed in the online shopping system.

FIG. 13 is a function block diagram according to a second embodiment of the present invention.

FIG. 14 is a diagram illustrating an example of an arrival notice mail according to the second embodiment of the present invention.

FIG. 15 is a diagram illustrating processing that is executed in the second embodiment of the present invention.

FIG. 16 is a diagram illustrating processing that is executed in the second embodiment of the present invention.

FIG. 17 is a function block diagram according to modification examples.

FIG. 18 is a table that is referred to in a description of the specifics of control exerted by a back-in-stock notification control unit in Modification Example (1).

FIG. 19 is a table that is referred to in a description of the specifics of control exerted by the back-in-stock notification control unit in Modification Example (2).

FIG. 20 is a diagram illustrating a screen example of an item page in Modification Example (3).

FIG. 21 is a table showing an example of information for identifying an item portion.

FIG. 22 is a table that is referred to in a description of the specifics of control exerted by the back-in-stock notification control unit in Modification Example (3).

FIG. 23 is a diagram illustrating an example of an item page in Modification Example (4).

FIG. 24 is a diagram illustrating an example of an out-of-stock notice mail.

FIG. 25 is a diagram that is referred to in a description of the specifics of control exerted by the back-in-stock notification control unit in Modification Example (5).

FIG. 26 is a diagram illustrating an example of a confirmation screen which is displayed on a display unit.

FIG. 27 is a diagram illustrating a screen example of an item page in Modification Example (7).

### DESCRIPTION OF EMBODIMENTS

### 1. First Embodiment

Exemplary embodiments of the present invention are described in detail below with reference to the drawings. Described here is a case of applying a notification control system according to the present invention to an online shopping system that uses the Internet to sell merchandise.

[1-1. Hardware Configuration of the Online Shopping System]

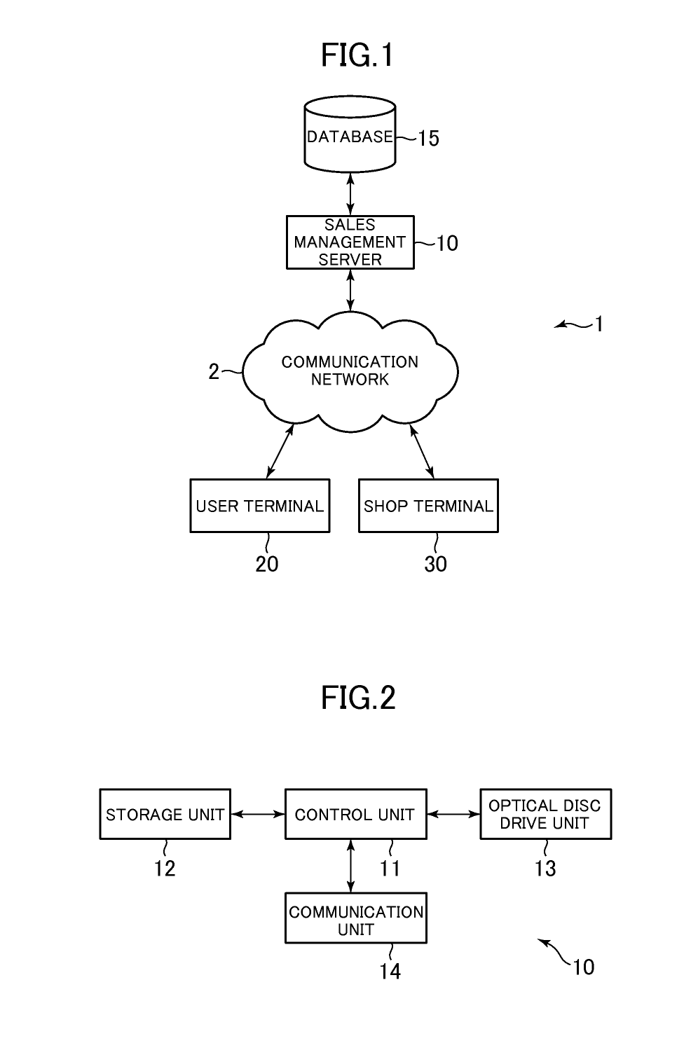

FIG. 1 is a diagram illustrating an example of the overall configuration of an online shopping system according to the embodiments of the present invention. As illustrated in FIG. 1, the online shopping system which is denoted by 1 includes a sales management server 10 (a notification control device), a database 15, a user terminal 20, and a shop terminal 30. The sales management server 10 is connected to the user terminal 20 and the shop terminal via a communication network 2 so that data can be transmitted/received to/from the user terminal 20 and the shop terminal 30.

FIG. 2 is a hardware configuration diagram of the sales management server 10. The sales management server 10 is, for example, a server computer. As illustrated in FIG. 2, the sales management server 10 includes a control unit 11, a storage unit 12, an optical disc drive unit 13, and a communication unit 14.

The control unit 11 includes, for example, one or a plurality of microprocessors. The control unit 11 executes processing in accordance with an operating system or program stored in the storage unit 12.

The storage unit 12 includes a main memory and auxiliary storage. For example, the main memory is a RAM, and the auxiliary storage is a hard disk drive, a solid state drive, or the like.

The optical disc drive unit 13 reads a program and data recorded on an optical disc (information recording medium). The program and data recorded on the optical disc are supplied to the storage unit 12 via the optical disc drive unit 13. In other words, the program and data recorded on the optical disc are read by the optical disc drive unit 13, and are stored in the storage unit 12.

The sales management server 10 may be configured to include a component for reading a program and data stored in an information recording medium (e.g., memory card) other than an optical disc so that the program and data are supplied to the storage unit 12 via the information recording medium other than the optical disc.

The communication unit 14 includes a network card. The communication unit 14 executes data communication over the communication network 2. The program and data may be supplied to the storage unit 12 over the communication network 2.

The sales management server 10 can access the database 15. The database 15 may be built on the sales management server 10 or on a server separate from the sales management server 10.

The database 15 stores various types of information necessary to provide merchandise to users. The information stored in the database 15 is described later (see FIGS. 8 to 10).

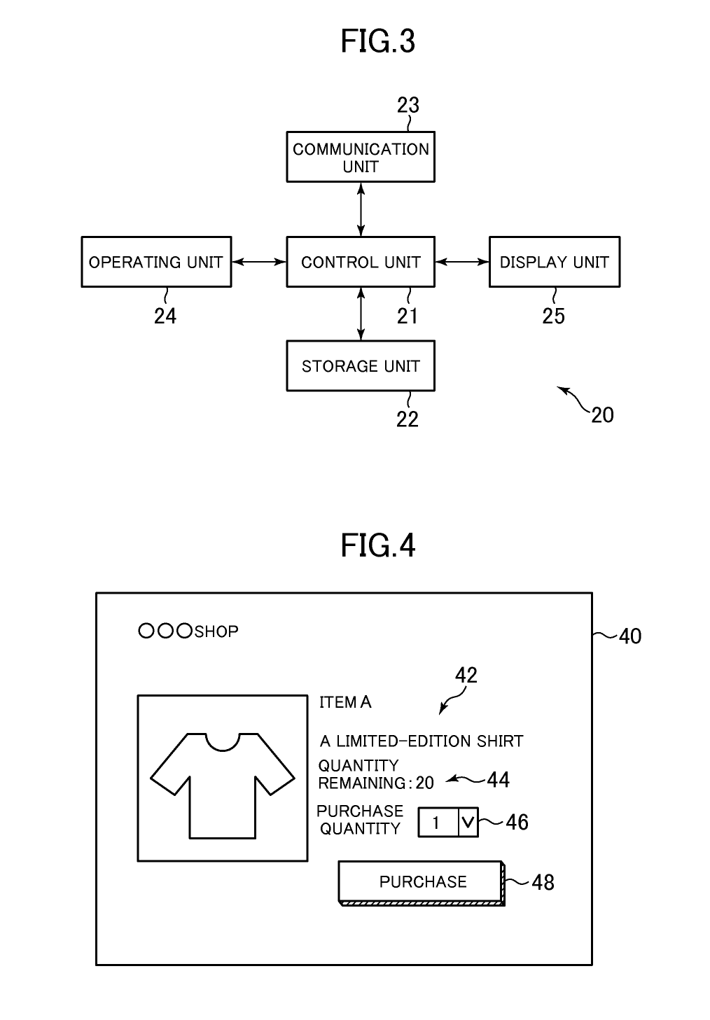

FIG. 3 is a hardware configuration diagram of the user terminal 20. The user terminal 20 is a computer operatedby a user, for example, a cellular phone (including smartphones), a portable information terminal (including tablet computers), or a personal computer. As illustrated in FIG. 3, the user terminal 20 includes a control unit 21, a storage unit 22, a communication unit 23, an operating unit 24, and a display unit 25. The hardware configurations of the control unit 21, the storage unit 22, and the communication unit 23 are substantially the same as those of the control unit 11, the storage unit 12, and the communication unit 14, and descriptions thereof are therefore omitted.

The operating unit 24 is for the user to operate. The operating unit 24 is, for example, a mouse, a keyboard, or a touch panel. The operating unit 24 transmits the specifics of an operation made by the user to the control unit 21.

The display unit 25 is, for example, a liquid crystal display unit or an organic EL display unit. The display unit 25 displays a screen following an instruction of the control unit 21.

The shop terminal 30 is an information processing device that is set up in a shop. The detailed configuration of the shop terminal 30 is omitted here in order to simplify the description. The shop terminal 30 is, for example, a known personal computer with which the count of in-stock pieces of an item can be updated. The shop terminal 30 is operated by a staff member of the shop. Data about the specifics of the operation is transmitted to the sales management server 10 over the communication network 2.

[1-2. Flow up to Item Purchasing by the User]

The flow up to the purchasing of an item by the user is described next with reference to a screen displayed on the display unit 25. In this embodiment, an item page for purchasing an item is displayed on the display unit 25 when the user operates the user terminal 20 to access the sales management server 10.

FIG. 4 is a diagram illustrating a screen example of an item page. As illustrated in FIG. 4, an item page 40 displays basic information 42, which is about an item sold by a shop, an in-stock count 44, which indicates the current count of in-stock pieces of the item, an input form 46, in which the user enters the purchase quantity of the item, and a purchase button 48, which is used by the user to purchase the item.

In the screen example of FIG. 4, the item is still in stock as indicated by the in-stock count 44, and the user can purchase the item. For example, when the user enters the purchase quantity of the item in the input form 46 and selects the purchase button 48, the screen shifts to a page for entering a shipping address, a payment method, and the like, thereby completing the operation for purchasing the item.

After the operation for purchasing the item is finished, the database 15 is updated so as to reflect the specifics of the purchase. For instance, the database 15 is updated so that the in-stock count 44 of the item decreases by the count of pieces of the item purchased by the user. Information indicating the specifics of a purchase made by the user is transmitted from the sales management server 10 to the shop terminal 30, and a staff member of the shop ships the item.

As described above, the user can purchase the item on the item page 40 when the item is still in stock whereas the user cannot purchase the item on the item page 40 in the case where the item has gone out of stock.

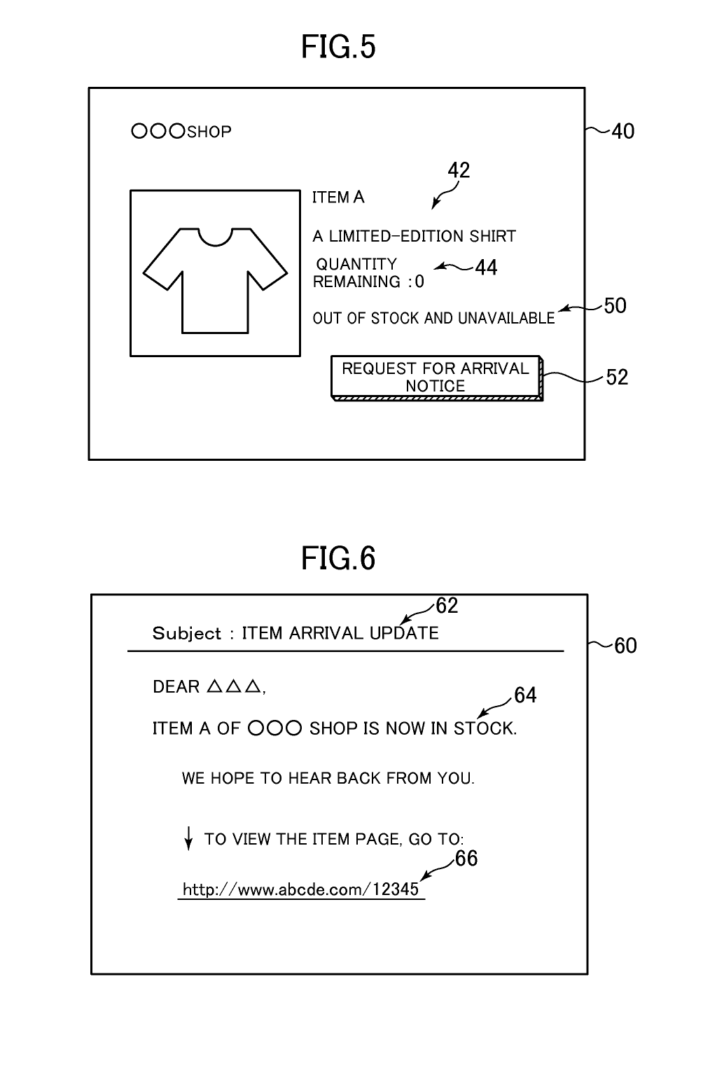

FIG. 5 is a diagram illustrating a screen example of the item page 40 that is displayed when an item is out of stock. As illustrated in FIG. 5, a message 50 to the effect that the item is out of stock and cannot be purchased is displayed. Here, the input form 46 and the purchase button 48 are removed from the item page 40 so that the user cannot order the item.

The item page 40 also displays an arrival notice request button 52 as illustrated in FIG. 5. In the case where the user selects the arrival notice request button 52, the user is notified of the arrival of the out-of-stock item when the item arrives. Here, a case where e-mail is transmitted to the user is described as an example of the arrival notice. E-mail transmitted as an arrival notice is hereinafter simply referred to as arrival notice mail.

FIG. 6 is a diagram illustrating an example of the arrival notice mail. As illustrated in FIG. 6, the arrival notice mail which is denoted by 60 includes a subject 62 and a message 64 which indicate that the item has arrived, and a link 66 to the item page 40. When the user opens the arrival notice mail 60 and selects the link 66, the display unit 25 displays the item page 40. In the case where the item is still in stock at the time the user accesses the item page 40, for example, the item page 40 as the one illustrated in FIG. 4 is displayed and the user can purchase the item.

On the other hand, the item may sell out soon after its arrival and become out of stock again by the time the user accesses the item page 40 by selecting the link 66. The user in this case cannot purchase the item and is likely to need an arrival notice mail once more when the item comes back in stock (hereinafter simply referred to as back-in-stock notice mail). This embodiment is therefore configured so that the transmission of the back-in-stock notice mail is set automatically without requiring the user to select the arrival notice request button 52 again, thus reducing bothers to the user. Details of this technology are described below.

[1-3. Functions Implemented in the Online Shopping System]

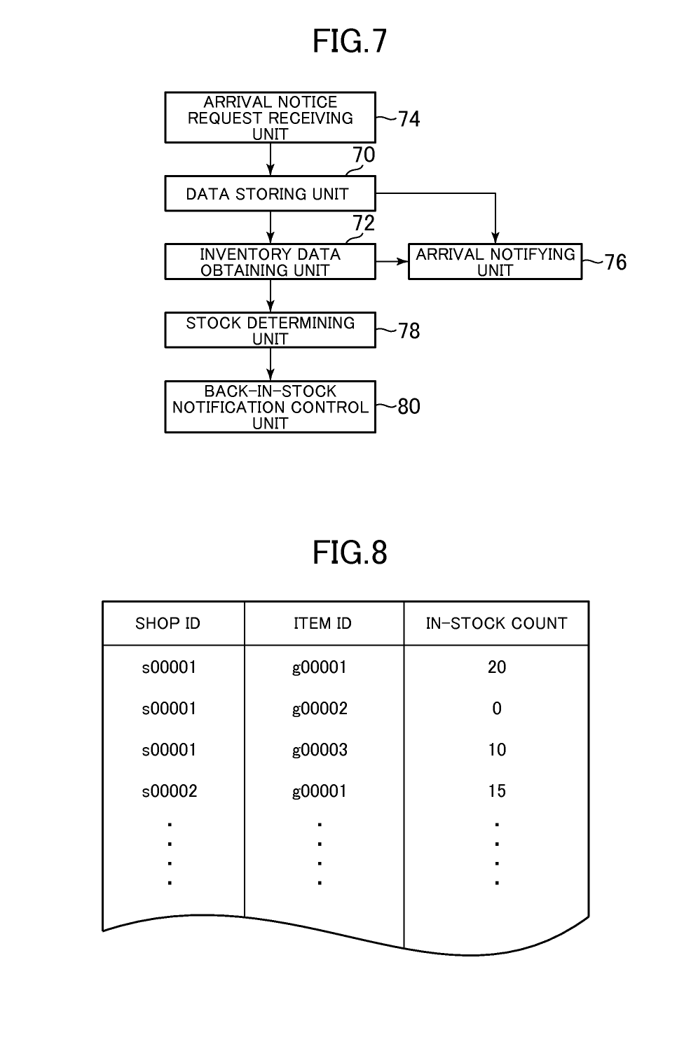

FIG. 7 is a function block diagram illustrating functions that are implemented in the online shopping system 1. As illustrated in FIG. 7, the functions include a data storing unit 70, an inventory data obtaining unit 72, an arrival notice request receiving unit 74, an arrival notifying unit 76, a stock determining unit 78, and a back-in-stock notification control unit 80. Of these functions, the data storing unit 70 is implemented mainly by the database 15, and the rest are implemented mainly by the control unit 11.

[1-3-1. Data Storing Unit]

The data storing unit 70 stores various types of data necessary to sell merchandise. The description given here takes as an example a case where the data storing unit 70 stores inventory data, which is about the inventory of an item, user data, which is about each user who uses the online shopping system 1, and arrival notification data, which is for identifying a user who has requested for an arrival notice.

[Inventory Data]

FIG. 8 is a table showing a data storage example of the inventory data. In the inventory data, a shop ID for identifying a shop, an item ID for identifying an item that is carried by the shop, and the count of in-stock pieces of the item are stored in association with one another as shown in FIG. 8. The inventory data is updated in response to a user's purchase operation or the operation of the shop's staff member.

For example, the inventory data is updated depending on the utilization state of the shop. The definition of the utilization state here includes the utilization state of a virtual shop in the online shopping system 1 and the utilization state of the shop in the real world (e.g., the state of the purchase of the item by customers who actually visit the shop). In other words, what is stored as the inventory data is updated when, for example, the item sells at the virtual shop for online shopping and when the item sells in the shop of the real world.

The inventory data is also updated in relation to the item arrival state. For example, when an item arrives at a shop, what is stored as the inventory data is updated based on the specifics of an operation performed by the shop's staff member. Here, the shop's staff member inputs the count of pieces of the item that have arrived, and the in-stock count increases by the input count of arriving pieces in a record of the inventory data that holds the shop ID of the shop and the item ID of the item.

[User Data]

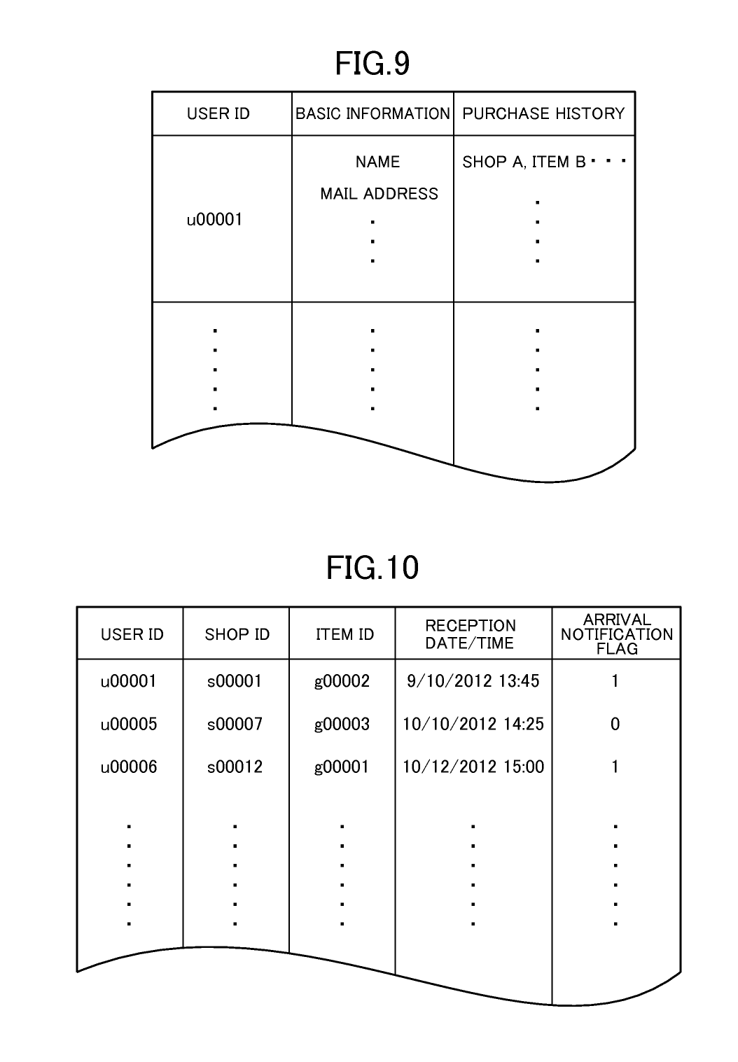

FIG. 9 is a table showing a data storage example of the user data. In the user data, a user ID for identifying a user, basic information about the user (for example, the name, a mail address, contact information, and a shipping address), and a purchase history about items purchased by the user in the past (for example, the shop ID of a store used by the user, the item ID of a purchased item, a purchase quantity, and a purchase date/time) are stored in association with one another as shown in FIG. 9.

A new record is generated in the user data when, for example, a user signs up for the use of the online shopping system 1. A user ID assigned to the signed up user and basic information input by the user are stored in the generated record. Once the sign up is complete, the user can purchase an item on the item page 40. When the user purchases the item, the purchase history of the user is updated.

[Arrival Notification Data]

FIG. 10 is a table showing a data storage example of the arrival notification data. In the arrival notification data, a user ID, a shop ID, an item ID, an arrival notice request reception date/time, and an arrival notification flag are stored as shown in FIG. 10. A user whose user ID is stored in the arrival notification data is a user who has made an arrival notice request.

Arrival notification to a user is registered in the case where the user selects the arrival notice request button 52 on the item page 40. For example, a new record is generated in the arrival notification data, and the user ID of the user who has selected the arrival notice request button 52, the shop ID of a shop that carries an item on the item page 40, the item ID of the item, and the current date/time are stored in the record in association with one another. An initial value (here, “1”) is stored as the arrival notification flag.

The arrival notification flag is identification information for identifying whether to notify the user of the arrival. Here, a value “1” of the arrival notification flag (a first value) indicates that, for example, the user has not been notified of the arrival yet and is to receive the arrival notice, and a value “0” of the arrival notification flag (a second value) indicates that, for example, the user has already been notified of the arrival and is not to receive the arrival notice.

In this embodiment, the value of the arrival notification flag is updated from “1” to “0” in association with a user to whom the arrival notice mail 60 has been transmitted by the arrival notifying unit 76, which is described later. Accordingly, when the item goes out of stock again and then comes back in stock, a back-in-stock notice mail is not transmitted to the user if the arrival notification flag remains “0”.

Data stored in the data storing unit 70 is not limited to the example given above. The data storing unit 70 can store various types of data necessary for users to purchase merchandise. For instance, the data storing unit 70 may store data about the specifics of an arrival notice (e.g., a template for the arrival notice mail 60). To give another example, the data storing unit 70 may store data indicating basic information of an item (e.g., the genre, an image, the price, and a shipping fee) and data about each item page (e.g., the URL, an image, and the layout).

[1-3-2. Inventory Data Obtaining Unit]

The inventory data obtaining unit 72 obtains what is stored in a storage that stores data about the inventory of merchandise (for example, the data storing unit 70). The inventory data obtaining unit 72 in this embodiment obtains, for each item, the count of in-stock pieces of the item which is stored in the inventory data.

[1-3-3. Arrival Notice Request Receiving Unit]

The arrival notice request receiving unit 74 receives a request for an item arrival notice which is made by a user. Here, performing a given operation (for example, selecting the arrival notice request button 52) on a user's unit corresponds to the user's making an arrival notice request.

The arrival notice request receiving unit 74 receives an arrival notice request when, for example, a user selects a given indicator that is included in the item page 40 (e.g., the arrival notice request button 52). In other words, the arrival notice request receiving unit 74 receives an arrival notice request by being notified of the fact that a user has selected the arrival notice request button 52.

When receiving an arrival notice request, the arrival notice request receiving unit 74 in this embodiment sets identification information (e.g., the arrival notification flag) so that a user whose arrival notice request is received is notified of the arrival. Here, setting the arrival notification flag to “1” corresponds to setting identification information so that the user is notified of the arrival. For example, the arrival notice request receiving unit 74 generates a new record in the arrival notification data upon reception of an arrival notice request, and stores a user ID, a shop ID, an item ID, and the initial value of the arrival notification flag (here, “1”) in the generated record.

[1-3-4. Arrival Notifying Unit]

The arrival notifying unit 76 notifies an arrival of an item to a user (namely, a user who has requested for an arrival notice) when the item arrives. Here, transmitting a message or displaying an image corresponds to notifying the arrival. Specifically, the arrival notifying unit 76 notifies the arrival by transmitting a message that informs of the arrival of the item (e.g., the arrival notice mail 60) or by displaying on the display unit 25 an image indicating the arrival of the item.

When an item arrives, the arrival notifying unit 76 in this embodiment determines whether to notify a user whose arrival notice request has been received of the arrival, based on identification information for identifying whether or not the user is to be notified of the arrival (e.g., the arrival notification flag). In the case where an item that has been out of stock arrives, for example, the arrival notifying unit 76 refers to the arrival notification data to identify users who have requested for an arrival notice of the item. The arrival notifying unit 76 transmits the arrival notice mail 60 to those who have “1” as the arrival notification flag out of the identified users, and does not transmit the arrival notice mail 60 to those who have “0” as the arrival identification flag out of the identified users.

The arrival notifying unit 76 in this embodiment also sets identification information so that a user whose arrival notice request has been received is not notified that the item is back in stock once the user is notified of the arrival of the item. Here, setting the arrival notification flag to “0” corresponds to setting identification information so that the user is not notified of the arrival. Specifically, the arrival notifying unit 76 controls so that a back-in-stock notice mail is not transmitted to a user by changing the value of the arrival notification flag to “0” for the user after transmitting the arrival notice mail 60 to the user.

[1-3-5. Stock Determining Unit]

The stock determining unit 78 determines whether or not an item is in stock when a user (namely, a user who has made an arrival notice request) accesses the item page 40 (namely, the item page 40 of the item for which the arrival notice request has been made) after the item arrives. “When the user accesses the item page 40” is the time when access to the item page 40 is received, or a point in time past the reception of the access, for example, the time when inventory data is referred to in order to display the item page 40.

The stock determining unit 78 determines whether or not an item is in stock by, for example, determining whether or not the in-stock count indicated by the inventory data is equal to or more than a reference count (e.g., 1). That the in-stock count of an item is equal to or more than a reference count corresponds to the item's being in stock, and that the in-stock count of an item is less than the reference count corresponds to the item's being out of stock. In other words, a change in the in-stock count of an item from less than a reference count to equal to or more than the reference count means that an item which has been out of stock arrives.

It is sufficient if the determination processing by the stock determining unit 78 is executed when the user accesses the item page 40, irrespective of whether the user has actually opened the arrival notice mail 60 or not. The determination processing by the stock determining unit 78 may be executed after the arrival notice mail 60 is transmitted, or before the arrival notice mail 60 is transmitted.

[1-3-6. Back-in-stock Notification Control Unit]

The back-in-stock notification control unit 80 controls a back-in-stock notification to a user based on the result of the determination by the stock determining unit 78. A back-in-stock notice is an arrival notice that is sent in the case where an item goes out of stock again and then comes back in stock, and is a message informing that an item is back in stock, or an image indicating that an item is back in stock. The contents of the back-in-stock notice may be the same as those of the arrival notice, or may differ from those of the arrival notice.

“Controlling a back-in-stock notification” is to exert control with regard to whether to notify a user that an item is back in stock, for example, to exert control with regard to the registration or stop (cancellation) of a back-in-stock notification. Here, setting the value of the arrival notice flag to “1” (in other words, deeming that a user has made an arrival notice request, or registering for arrival notification) corresponds to exerting control so that a back-in-stock notice is sent, and setting the value of the arrival notice flag to “0” (in other words, deeming that a user has requested to withdraw an arrival notice request, or cancelling registration for arrival notification) corresponds to exerting control so that a back-in-stock notice is not sent.

In the case where the stock determining unit 78 determines that an item is out of stock, the back-in-stock notification control unit 80 in this embodiment sets identification information (e.g., the arrival notification flag) so that a user from whom an arrival notice request is received is notified that the item is back in stock. Here, when the stock determining unit 78 determines that an item is out of stock, the back-in-stock notification control unit 80 updates the value of the arrival notification flag from “0” to “1”, thereby exerting control so that the user is notified that the item is back in stock.

[1-4. Processing Executed in the First Embodiment]

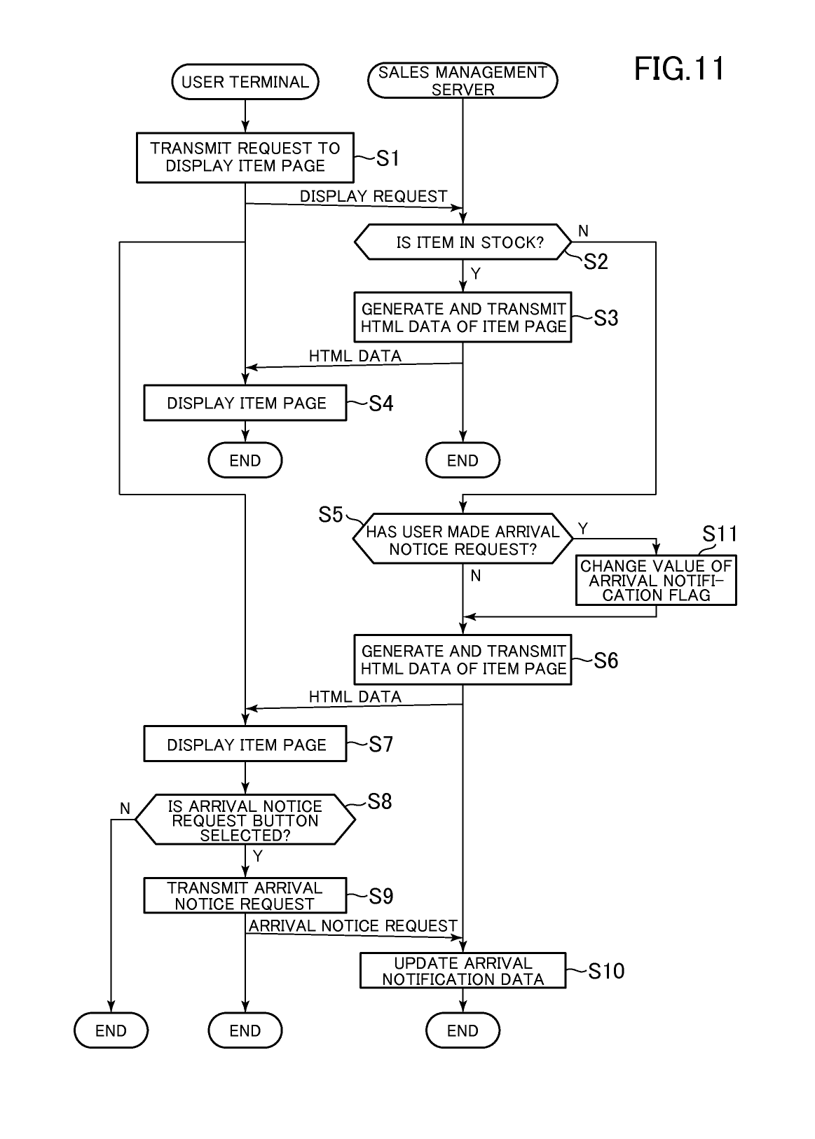

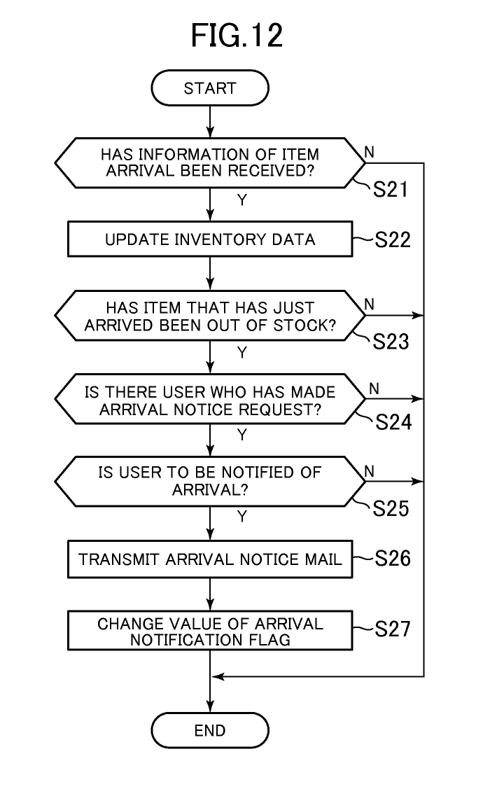

FIGS. 11 and 12 are diagrams illustrating processing that is executed in the online shopping system 1. FIG. 11 illustrates processing that is executed when a user accesses the item page 40.

FIG. 12 illustrates processing that is executed when the sales management server 10 notifies an item's arrival or coming back in stock. The function blocks are implemented by executing the processing of FIG. 11 and FIG. 12.

The processing of FIG. 11 is described first. The control unit 11 of the sales management server 10 operates as programmed by a program stored in the storage unit 12 and the control unit 21 of the user terminal 20 operates as programmed by a program stored in the storage unit 22, thereby executing the processing of FIG. 11. For simplification, the description assumes that the establishment of a session between the sales management server 10 and the user terminal 20 and the completion of the user's given log-in operation precede the execution of the processing described below.

First, the control unit 21 in the user terminal 20 transmits a request to display the item page 40 to the sales management server 10 (S1) in response to the user's operation (for example, the operation of selecting a link to the item page 40) as illustrated in FIG. 11. It is assumed here that, when information is transmitted from the user terminal 20 to the sales management server 10, an IP address, a user ID, and others are transmitted. The sales management server 10 can thus identify which user is accessing the item page 40.

The sales management server 10 receives the request to display the item page 40 and the control unit 11 refers to the inventory data to determine whether or not an item on the item page 40 is in stock (S2). The assumption here is that the association between the item page 40, a shop ID, and an item ID is stored in the storage unit 12 of the sales management server 10. In S2, the control unit 11 refers to this association to obtain a shop ID and an item ID that are associated with the item page 40 for which the display request has been received. The control unit 11 then refers to an in-stock count stored in a record of the inventory data that holds the obtained shop ID and item ID.

When it is determined that the item is in stock (S2: Y), the control unit 11 generates HTML data of the item page 40 that includes the input form 46 and the purchase button 48, and transmits the HTML data to the user terminal 20 (S3).

The user terminal 20 receives the HTML data and the control unit 21 displays the item page 40 on the display unit 25 (S4). The item page 40 displayed in S4 is as illustrated in FIG. 4. Subsequently, processing of purchasing the item is executed depending on the user's operation. The purchasing processing is known processing and a description thereof is therefore omitted.

When it is determined that the item is out of stock (S2: N), on the other hand, the control unit 11 refers to the arrival notification data to determine whether or not the user has requested for an arrival notice of the item in the past (S5). In S5, the control unit 11 determines whether or not the arrival notification data includes a record that stores the user ID of a user who has made a request to display the item page 40, the shop ID of a shop on the item page 40 in question, and the item ID of the item on the item page 40 in question.

When it is determined that the user has not requested for the arrival notice in the past (S5: N), the control unit 11 generates HTML data of the item page 40 that includes the message 50 to the effect that the item is out of stock and the arrival notice request button 52, and transmits the HTML data to the user terminal 20 (S6).

The user terminal 20 receives the HTML data and the control unit 21 displays the item page 40 on the display unit 25 (S7). The item page 40 displayed in S7 is as illustrated in FIG. 5, where the input form 46 and the purchase button 48 are not displayed, which means that the user cannot perform the operation of purchasing the item.

The control unit 21 determines whether or not the arrival notice request button 52 is selected (S8). When it is determined that the arrival notice request button 52 is selected (S8: Y), the control unit 21 transmits to the sales management server 10 a notice for informing that the arrival notice request button 52 is selected (namely, an arrival notice request) (S9).

The sales management server 10 receives the notice informing that the arrival notice request button 52 is selected (namely, an arrival notice request), and the control unit 11 updates the arrival notification data (S10) and ends the processing. In S10, the control unit 11 creates a new record in the arrival notification data to store in the record the user ID of the user who has selected the arrival notice request button 52, the shop ID of the shop on the item page 40, the item ID of the item on the item page 40, the current date/time, and the initial value of the arrival notification flag. Arrival notification and a back-in-stock notification to the user are controlled based on the arrival notification data updated in S10.

Processing of notifying an item's arrival or coming back in stock to a user (the processing of FIG. 12) is described. The processing of FIG. 12 is executed by, for example, the control unit 11 of the sales management server 10 by operating as programmed by a program stored in the storage unit 12.

As illustrated in FIG. 12, the control unit 11 in the sales management server 10 first determines whether or not information of the arrival of an item has been received from the shop terminal 30 (S21). For example, when a staff member of a shop operates the shop terminal 30 to input the count of pieces of an item that have arrived, data that includes the shop ID of the shop, the item ID of the item, and the input item piece count is transmitted to the sales management server 10. The control unit 11 determines in S21 whether or not this data has been received.

When it is determined that information of the arrival of an item has been received (S21: Y), the control unit 11 updates the inventory data based on the received information (S22). In S22, the control unit 11 updates the in-stock count in one of the records of the inventory data that holds the shop ID and the item ID that are indicated by the data received from the shop terminal 30.

The control unit 11 determines whether or not the item that has just arrived has been out of stock (S23). In S23, the control unit 11 determines whether or not the in-stock count of the item whose arrival information has been received in S21 has been less than a reference count (e.g., 1).

When it is determined that the item that has just arrived has been out of stock (S23: Y), the control unit 11 refers to the arrival notification data to determine whether or not there is a user who has requested for an arrival notice of the item that has just arrived (S24). In S24, the control unit 11 determines whether or not a record that stores the shop ID of the shop at which the item has arrived and the item ID of this item is included among records of the arrival notification data.

When it is determined that there is a user who has requested for the arrival notice (S24: Y), the control unit 11 refers to the arrival notification flag of this user to determine whether to notify the user of the arrival (S25). In S25, the control unit 11 determines whether or not the value of the arrival notification flag of the user who has requested for the arrival notice is “1”.

When it is determined that the user is to be notified of the arrival (S25: Y), the control unit 11 transmits the arrival notice mail 60 to the user who has made the arrival notice request (S26), and changes the value of the user's arrival notification flag to “0” (S27). In S26, the control unit 11 generates the arrival notice mail 60 for the item that has arrived and sends the mail to a user who has “1” as the value of the arrival notification flag.

Thereafter, when the user opens the arrival notice mail 60 transmitted in S26 and selects the link 66, for example, a request to display the item page 40 is made and S1 of FIG. 11 is therefore executed again. In this case, whether or not the item is in stock is determined in S2 and, when it is determined that the item is out of stock, the processing moves to S5. While this embodiment describes a case where the arrival notification data is referred to in S5 to execute processing of determining whether or not the user has requested for the arrival notice, the value of the arrival notification flag may be changed without executing S5 when it is determined in S2 that the item is out of stock. In other words, when the user selects the link 66 in the arrival notice mail 60, for example, S5 may be omitted to execute only the arrival notification flag changing processing when it is determined that the item is out of stock. In this case, when the shop ID and item ID of the shop and item on the item page 40 requested by the user to be displayed and the user ID of the user who has made the display request are not stored in the arrival notification data, this record does not exist and, naturally, the value of the arrival notification flag is not changed.

When it is determined in S5 that the user has made the arrival notice request in the past (S5: Y), the control unit 11 refers to the arrival notification data, changes the value of the arrival notification flag of this user to “1” (S11), and moves to S6 to S10. In this case, a screen informing that an item has gone out of stock again may be displayed on the display unit 25 of the user terminal 20 before the item page 40 is displayed, and the screen then shifts to the item page 40. This screen may also display an indicator for stopping a back-in-stock notification. When the indicator is selected by the user, the value of the arrival notification flag stored in the arrival notification data is changed to “0” so that a back-in-stock notification is stopped from then on.

In S11, the control unit 11 changes the value of the arrival notification flag to “1” in a record of the arrival notification data that stores the user ID of the user who has requested to display the item page 40, the shop ID of the shop on the item page 40 in question, and the item ID of the item on the item page 40 in question. At the time the processing of FIG. 12 is executed subsequently, the value of the arrival notification flag of this user is “1” and the arrival notice mail 60 as a back-in-stock notice (namely, a back-in-stock notice mail) is accordingly transmitted in S26.

According to the online shopping system 1 described above, even when an item has gone out of stock again by the time a user who has received the arrival notice mail 60 accesses the item page 40 by, for example, selecting the link 66, the user can receive a back-in-stock notice because the value of the arrival notification flag automatically changes to “1”. In other words, it is regarded that the user has made a request for a back-in-stock notice, and the user therefore does not need to perform an operation for receiving a back-in-stock notice, which reduces the bothers related to a back-in-stock notification of an item.

### 2. Second Embodiment

Another embodiment of the present invention is described next. For example, in the case of changing the value of the arrival notification flag from “1” to “0” after the arrival notice mail 60 is transmitted as in the first embodiment, a back-in-stock notice mail is not transmitted from then on unless the value of the arrival notification flag changes to “1”. When the value of the arrival notification flag is kept to “1” after the arrival notice mail 60 is transmitted, the user can receive a back-in-stock notice mail each time the item comes back in stock in the future.

In this case, when the item is in stock at the time the user who has made the arrival notice request accesses the item page 40, the user is likely to proceed to purchase the item on the item page 40. However, when the online shopping system is set so that the value of the arrival notification flag does not change to “0” unless the user performs a given cancellation operation (stop operation), the user has to receive an unnecessary back-in-stock notice mail endlessly. A second embodiment of the present invention therefore reduces bothers to the user by automatically changing the value of the arrival notification flag from “1” to “0” in this case so that a back-in-stock notice mail is not transmitted.

The online shopping system 1 of the second embodiment is the same as that of the first embodiment in terms of hardware configuration and flow up to item purchasing, and descriptions thereof are therefore omitted.

[2-1. Functions Implemented in the Second Embodiment]

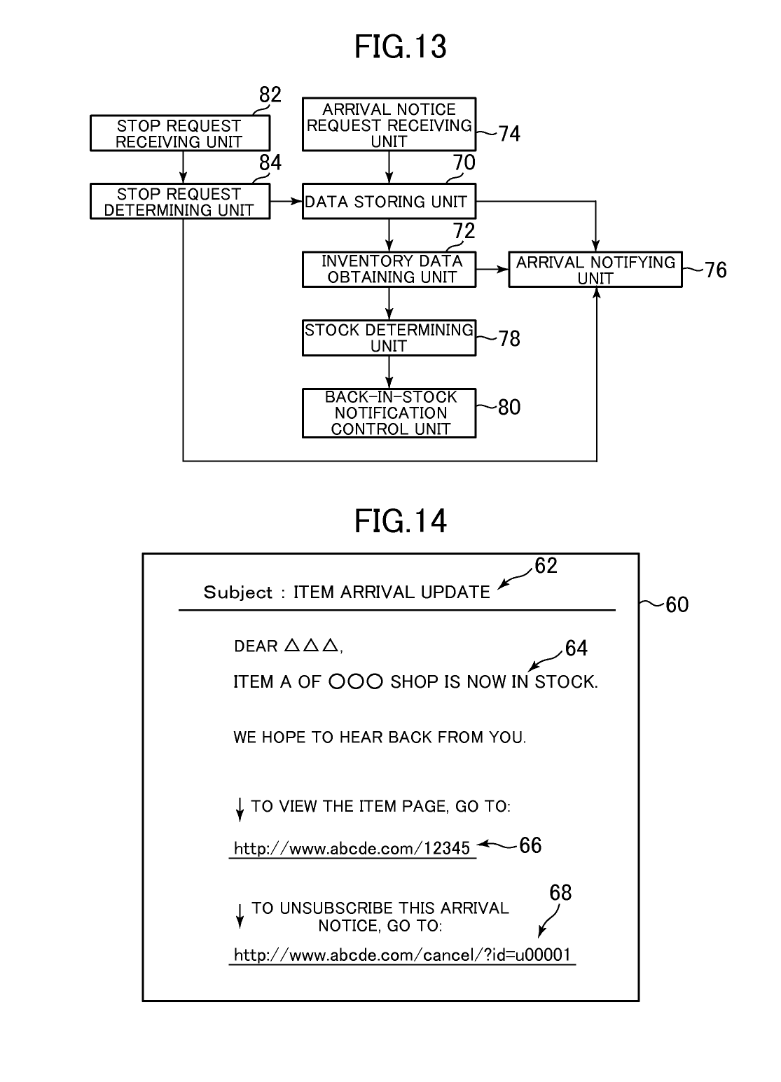

FIG. 13 is a function block diagram of the second embodiment. As illustrated in FIG. 13, a stop request receiving unit 82 and a stop request determining unit 84 are implemented in the second embodiment in addition to the functions of the first embodiment. These functions are implemented mainly by the control unit 11.

The stop request receiving unit 82 receives a request to stop an arrival notice which is made by a user. Here, a user's performing a given operation after an arrival notice request is made corresponds to making a stop request, and receiving a notice that this operation has been made corresponds to receiving a stop request.

FIG. 14 is a diagram illustrating an example of the arrival notice mail 60 according to the second embodiment. As illustrated in FIG. 14, the arrival notice mail 60 of the second embodiment includes a link 68 for making the stop request. Here, the user's selecting the link 68 and thereby requesting access to the sales management server 10 from the user terminal 20 corresponds to making a stop request.

The stop request determining unit 84 determines whether or not a stop request has been received from a user who has made an arrival notice request. When receiving a stop request, the stop request determining unit 84 stops a back-in-stock notice to the user. Stopping a back-in-stock notice means exerting control so as not to notify that an item is back in stock, here, setting the value of the arrival notification flag to “0”, or deleting the record of the user itself from the arrival notification data.

Described next are functions of the arrival notifying unit 76 and the back-in-stock notification control unit 80 of the second embodiment that differ from those in the first embodiment.

The arrival notifying unit 76 of the first embodiment changes the value of the arrival notification flag to “0” in the case where the arrival notice mail 60 is transmitted. The arrival notifying unit 76 of the second embodiment does not change the value of the arrival notification flag from “1” even after the arrival notice mail 60 is transmitted.

The arrival notifying unit 76 of the second embodiment notifies that an item is back in stock to a user whose arrival notice request has been received for the duration from the reception of the arrival notice request to the reception of the stop request. For example, the arrival notifying unit 76 notifies the arrival in the case where the stop request has not been received, and does not notify the arrival in the case where the stop request has been received. In other words, the arrival notifying unit 76 in the second embodiment transmits a back-in-stock notice mail each time the item comes back in stock even after transmitting the arrival notice mail 60 once, unless the arrival notification flag changes to “0”.

The back-in-stock notification control unit 80 of the second embodiment stops notifying that an item is back in stock to a user whose arrival notice request has been received in the case where the stock determining unit 78 determines that the item is in stock. In other words, the back-in-stock notification control unit 80 deems that the stop request has been made, and exerts control so that the user is not notified of the item's coming back in stock. Here, the back-in-stock notification control unit 80 exerts control so that the user is not notified that the item is back in stock by updating the value of the arrival notification flag from “1” to “0”.

[2-2. Processing Executed in the Second Embodiment]

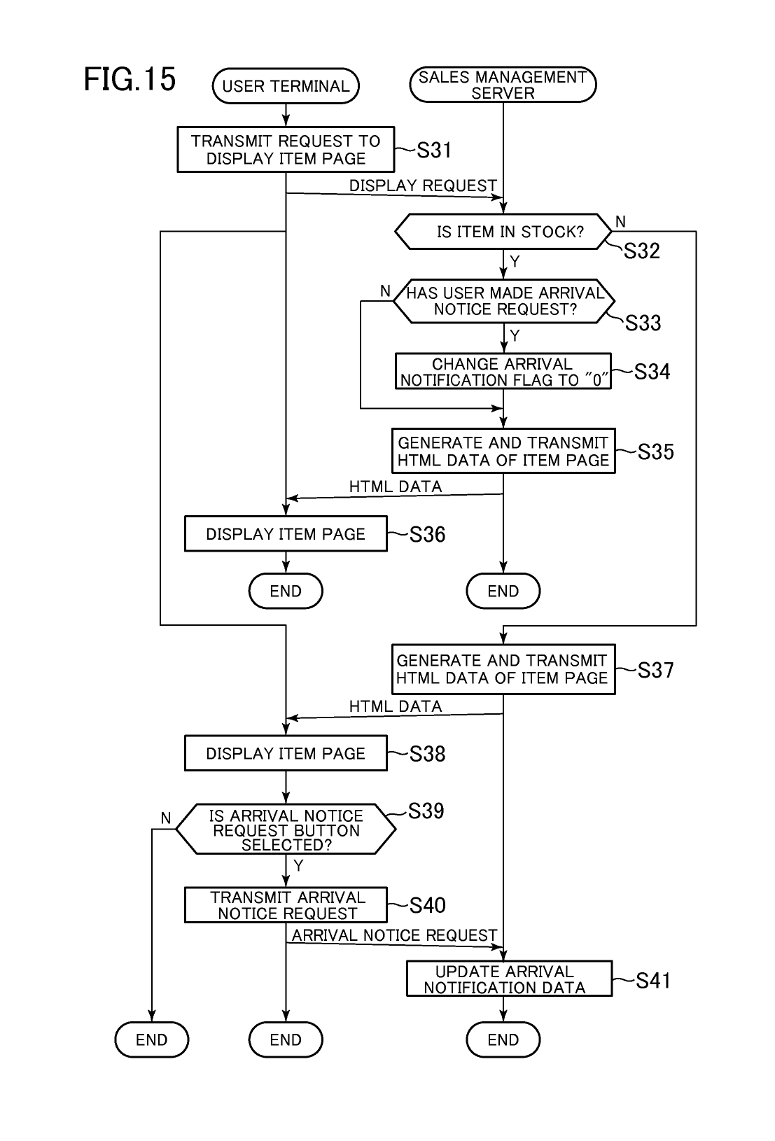

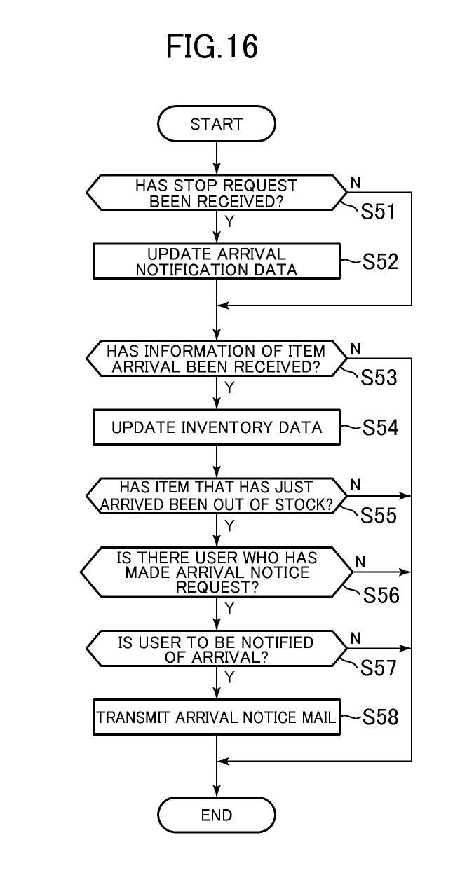

FIG. 15 and FIG. 16 are diagrams illustrating processing that is executed in the second embodiment. The processing of FIG. 15 and the processing of FIG. 16 respectively correspond to the processing of FIG. 11 and the processing of FIG. 12 which have been described in the first embodiment.

As illustrated in FIG. 15, S31 and S32 are the same as S1 and S2, respectively, and descriptions thereof are therefore omitted.

When it is determined in S32 that the item is in stock (S32: Y), the control unit 11 determines whether or not the user who has requested to display the item page 40 has made an arrival notice request (S33). S33 is the same as S5.

When it is determined that the user has made the arrival notice request (S33: Y), the control unit 11 refers to the arrival notification data and changes the value of the arrival notification flag to “0” (S34). In S34, the control unit 11 changes the value of the arrival notification flag to “0” in a record of the arrival notification data that stores the user ID of the user who has requested to display the item page 40, the shop ID of the shop on the item page 40 in question, and the item ID of the item on the item page 40 in question.

S35 to S41 are respectively the same as S3, S4, and S6 to S10. A processing step that corresponds to S11 does not need to be executed in the second embodiment, where the value of the arrival notification flag does not change even after the arrival notice mail 60 is transmitted.

As illustrated in FIG. 16, the control unit 11 determines whether or not a request to stop an arrival notice has been received from a user (S51). In S51, the control unit 11 determines whether or not a notice that the link 68 of the arrival notice mail 60 is selected has been received from the user terminal 20. Here, a user ID, a shop ID, and an item ID are stored as arguments of the link 68, and the control unit 11 obtains these pieces of information to identify which user has made a request to stop which arrival notice.

When it is determined that the stop request has been received (S51: Y), the control unit 11 updates the arrival notification data (S52). In S52, the control unit 11 sets the value of the arrival notification flag to “0” in a record of the arrival notification data for the user whose stop request has been received, and exerts control so that a back-in-stock notice mail is not transmitted to this user.

When it is determined that the stop request has not been received (S51: N), on the other hand, the control unit 11 moves to S53. Subsequent processing steps S53 to S58 are respectively the same as S21 to S26. However, S27 is not executed in the second embodiment, where the value of the arrival notification flag does not change even after the arrival notice mail 60 is transmitted.

As described above, when an item is in stock at the time a user accesses the item page 40, S34 is executed to change the value of the arrival notification flag to “0” so that it is determined through the execution of S57 that the user is not to be notified of the arrival in the future, with the result that a back-in-stock notice mail is not transmitted to the user.

According to the online shopping system 1 of the second embodiment, in the case where an item is still in stock at the time a user who has received the arrival notice mail 60 accesses the item page 40 by selecting the link 66, for example, the value of the arrival notification flag is automatically changed to “0” so that the user is not notified of the item's coming back in stock in the future. The user therefore does not have to receive a back-in-stock notice endlessly and, in addition, is not required to perform an operation for cancelling a back-in-stock notice because it is deemed that the arrival notice has been cancelled. Bothers related to a back-in-stock notification of an item are thus reduced.

### 3. Modification Examples

The present invention is not limited to the embodiments described above, and can be modified suitably without departing from the spirit of the present invention.

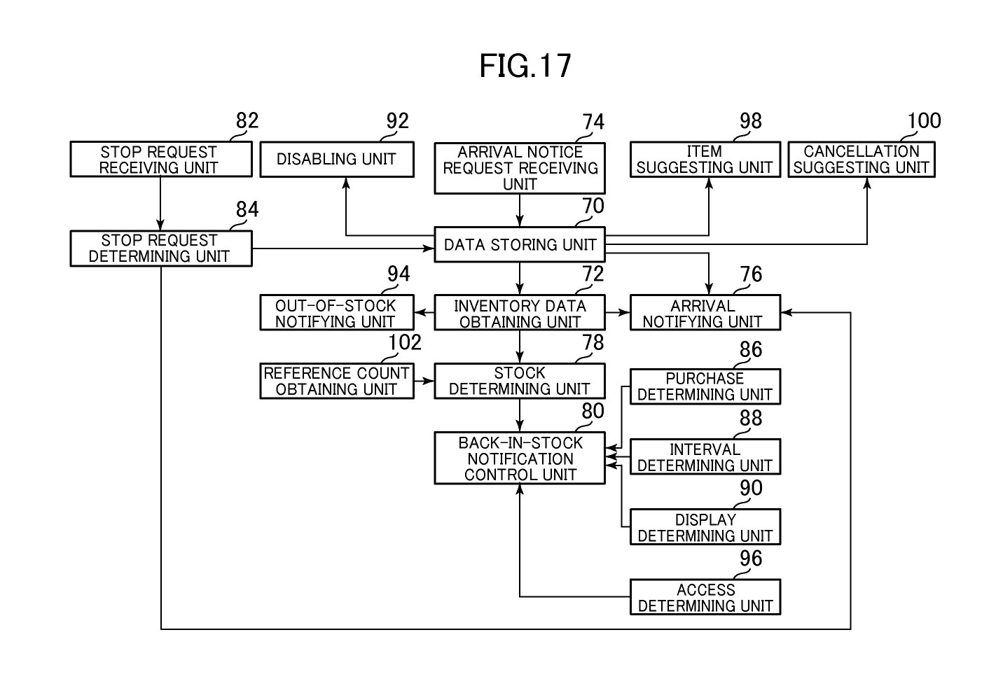

FIG. 17 is a function block diagram of modification examples. As illustrated in FIG. 17, a purchase determining unit 86, an interval determining unit 88, a display determining unit 90, a disabling unit 92, an out-of-stock notifying unit 94, an access determining unit 96, an item suggesting unit 98, a cancellation suggesting unit 100, and a reference count obtaining unit 102 are implemented in modification examples described below in addition to the functions of the embodiments described above. These functions are implemented mainly by the control unit 11.

(1) For example, there is a case where, although an item is out of stock at the time a user who has requested for an arrival notice accesses the item page 40, the user does not need a back-in-stock notice mail in the future because the user has already purchased the item and is accessing the item page 40 just to enter the user's review of the item or the like. Accordingly, whether or not a user who has requested for an arrival notice has purchased an item in question may be used as a condition for controlling a back-in-stock notification.

The online shopping system 1 according to this modification example includes the purchase determining unit 86. The purchase determining unit 86 determines whether or not a user who has requested for an arrival notice of an item has purchased the item (namely, an item for which the arrival notice request has been made) after the reception of the arrival notice request. In the following description, a “user” means a “user whose arrival notice request has been received”.

Here, a user's item purchase history is stored in the user data as shown in FIG. 9. For example, each time a user purchases an item on the item page 40, the shop ID of a shop from which the item is purchased, the item ID of the purchased item, and a time at which the item is purchased are stored in the user data as the user's purchase history.

The purchase determining unit 86 refers to the purchase history stored in the user data to determine whether or not the user has purchased an item for which an arrival notice request has been made after the reception of the arrival notice request. For example, the purchase determining unit 86 refers to a record of the purchase history stored in the user data that holds a purchase time later than the time of reception of the arrival notice request, and determines whether or not the record holds the user ID of the user who is accessing the item page 40, the shop ID of a shop on the item page 40, and the item ID of the item on the item page 40. In other words, the purchase determining unit 86 does not determine that the user has purchased the item for which the arrival notice request has been made even when the user has purchased the item for which the arrival notice request has been made before the time of reception of the arrival notice request.

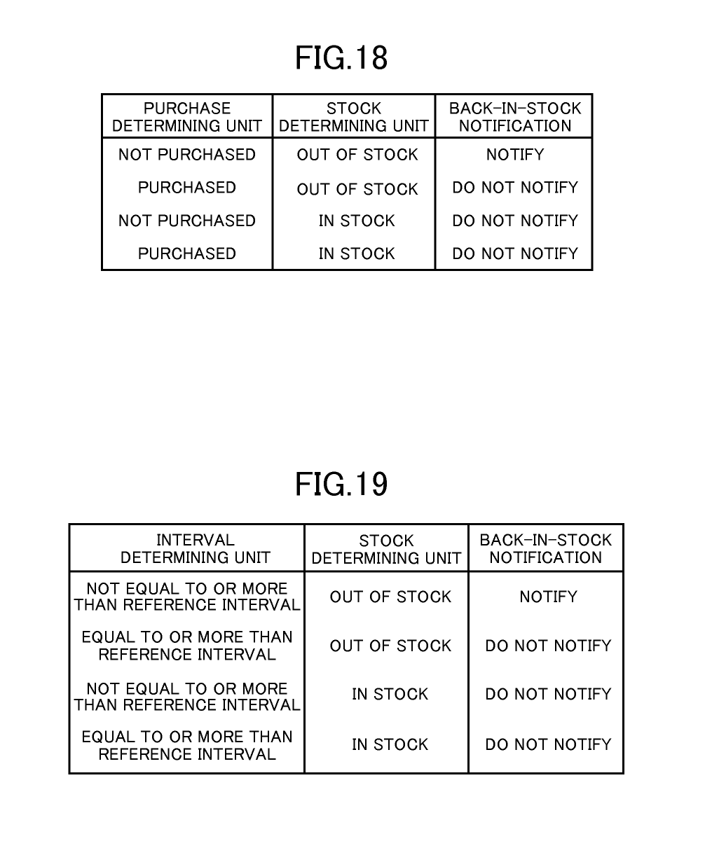

FIG. 18 is a table that is referred to in a description of the specifics of control exerted by the back-in-stock notification control unit 80 in Modification Example (1). The back-in-stock notification control unit 80 of Modification Example (1) controls a back-in-stock notification based on the result of the determination by the purchase determining unit 86 and the result of the determination by the stock determining unit 78.

As shown in FIG. 18, the back-in-stock notification control unit 80 exerts control so that the user is notified in the future that the item is back in stock when, for example, the purchase determining unit 86 determines that the user has not purchased the item and the stock determining unit 78 determines that the item is out of stock. In this case, because the user has not purchased the item yet and the item is out of stock at the time the user accesses the item page 40, the back-in-stock notification control unit 80 deems the need to send a back-in-stock notice mail as high and sets the arrival notification flag to “1”.

In the case where Modification Example (1) is applied to the first embodiment, changing the arrival notification flag from “0” to “1” corresponds to controlling so that the user is notified in the future that the item is back in stock. In the case where Modification Example (1) is applied to the second embodiment, on the other hand, keeping the arrival notification flag to “1” corresponds to controlling so that the user is notified in the future that the item is back in stock. The same applies when descriptions of the following modification examples refer to controlling so as to notify the user in the future of the item's coming back in stock.

When the purchase determining unit 86 determines that the user has purchased the item and the stock determining unit 78 determines that the item is out of stock, on the other hand, the back-in-stock notification control unit 80 exerts control so as not to notify the user in the future that the item is back in stock. In this case, because the user has already purchased the item although the item is out of stock at the time the user accesses the item page 40, the user may be accessing the item page 40 in order to enter a review of the item or the like. The back-in-stock notification control unit 80 therefore deems the need to send a back-in-stock notice mail as low and sets the arrival notification flag to “0”.

Keeping the arrival notification flag to “0” corresponds to controlling so as not to notify the user in the future of the coming back of the item in the case where Modification Example (1) is applied to the first embodiment. On the other hand, changing the arrival notification flag from “1” to “0” corresponds to controlling so as not to notify the user in the future of the coming back of the item in the case where Modification Example (1) is applied to the second embodiment. The same applies when descriptions of the following modification examples refer to controlling so as not to notify the user in the future of the item's coming back in stock.

As shown in FIG. 18, when the stock determining unit 78 determines that the item is in stock, the back-in-stock notification control unit 80 deems that the need to send a back-in-stock notice mail is low irrespective of the result of the determination by the purchase determining unit 86, and sets the arrival notification flag to “0”. This is because the user can immediately purchase the item when the item is still in stock at the time the user accesses the item page 40, and the need to send a back-in-stock notice mail is low irrespective of whether or not the user has purchased the item.

According to Modification Example (1), whether or not a user has purchased an item can be used as a condition for controlling a back-in-stock notification. Therefore, in the case where a user is accessing the item page 40 only to enter a review of a purchased item, for example, unnecessarily transmitting a back-in-stock notice mail to the user can be prevented.

(2) In the case where a long period of time has elapsed since the transmission of the arrival notice mail 60 to the user's access to the item page 40, for example, it may be that the user has forgotten about the item in the first place and have lost interest in the item. Aback-in-stock notice mail may therefore not be transmitted in such cases.

The online shopping system 1 of this modification example includes the interval determining unit 88. The interval determining unit 88 determines whether or not an interval between a time point related to the arrival of an item and the time of access to the item page 40 by a user (namely, the time when the access is received by the sales management server 10) is equal to or more than a reference interval.

The “time point related to the arrival of an item.” is at least one of the time when the user has made an arrival notice request (e.g., the time when the user selects the arrival notice request button 52), the time of reception of the arrival notice request from the user, the time when the user is notified of the arrival (e.g., the transmission date/time of the arrival notice mail 60), the time when the user receives the arrival notice (e.g., the reception date/time of the arrival notice mail 60), the time when the user checks the arrival notice (e.g., the time when the arrival notice mail 60 is opened), and the time of arrival of the item (e.g., the time when information of the arrival of the item is received from the shop terminal 30). Data indicating these time points is recorded in the data storing unit 70.

Described here is a case where the transmission date/time of the arrival notice mail 60 corresponds to the time point related to the arrival of an item. Specifically, the interval determining unit 88 determines whether or not a time interval between the transmission date/time of the arrival notice mail 60 and the date/time of the user's access to the item page 40 is equal to or more than a reference interval.

The reference interval only needs to be a predetermined time interval, and may be the same or vary depending on the shop or the item. For instance, a long reference interval may be set for an item that has a rarity value on the market and takes long to restock. The reference interval may also be the same or vary depending on the user. For instance, a long reference interval may be set for a user who uses the online shopping system 1 infrequently and takes long to access the item page 40.

FIG. 19 is a table that is referred to in a description of the specifics of control exerted by the back-in-stock notification control unit 80 in Modification Example (2). The back-in-stock notification control unit 80 of Modification Example (2) controls a back-in-stock notification based on the result of the determination by the interval determining unit 88 and the result of the determination by the stock determining unit 78.

As shown in FIG. 19, the back-in-stock notification control unit 80 exerts control so that the user is notified in the future that the item is back in stock when, for example, the interval determining unit 88 determines that the interval is not equal to or more than the reference interval and the stock determining unit 78 determines that the item is out of stock. In this case, because the item is out of stock at the time of access to the item page 40 despite the fact that the user has accessed the item page 40 relatively soon, the back-in-stock notification control unit 80 deems the need to send a back-in-stock notice mail as high and sets the arrival notification flag to “1”.

For example, when the interval determining unit 88 determines that the interval is equal to or more than the reference interval and the stock determining unit 78 determines that the item is out of stock, on the other hand, the back-in-stock notification control unit 80 exerts control so as not to notify the user in the future that the item is back in stock. In this case, because the item is out of stock at the time the user accesses the item page 40 and the user has taken long to access the item page 40, for example, the user may have forgotten about the item. The back-in-stock notification control unit 80 therefore deems the need to send a back-in-stock notice mail as low and sets the arrival notification flag to “0”.

As shown in FIG. 19, when the stock determining unit 78 determines that the item is in stock, the back-in-stock notification control unit 80 deems that the need to send a back-in-stock notice mail is low irrespective of the result of the determination by the interval determining unit 88, and sets the arrival notification flag to “0”. This is because the item is in stock and the user is likely to proceed to purchase the item irrespective of whether or not the user has taken long to access the item page 40.

According to Modification Example (2), for example, whether or not the interval is long between the transmission date/time of the arrival notice mail 60 and the date/time of the user's access to the item page 40 can be used as a condition for controlling a back-in-stock notification. For example, in the case where a long period of time has elapsed since the transmission of the arrival notice mail 60 to the user's access to the item page 40, the user may have lost interest in the item and transmitting a back-in-stock notice mail to the user can be prevented.

(3) In the case where the item page 40 includes information about a plurality of items, for example, a user who performs an operation of displaying the item page 40 but does nothing to display a portion of the item page 40 that corresponds to an item for which the user has made an arrival notice request may have lost interest in the item. A back-in-stock notice mail transmitted in such cases would be a bother to the user.

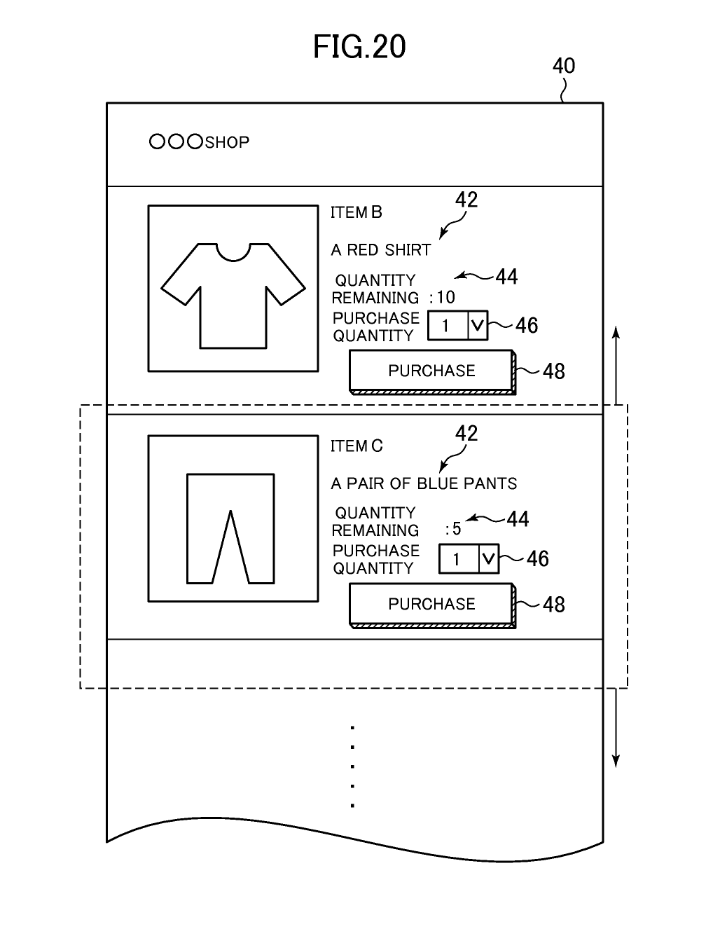

FIG. 20 is a diagram illustrating a screen example of the item page 40 in Modification Example (3). As illustrated in FIG. 20, the item page 40 includes information about a plurality of items. The item page 40 here is also larger than the display area of the display unit 25 and can be scrolled. Pieces of information about the respective items are displayed next to one another in the scrolling direction of the item page 40. For example, the basic information 42, the in-stock count 44, the input form 46, and the purchase button 48 are displayed for an item that is in stock. For an item that is out of stock, on the other hand, the message 50 which informs that the item is out of stock and the arrival notice request button 52 are displayed.

In FIG. 20, a portion of the item page 40 that is displayed on the display unit 25 is indicated by the dotted line. In other words, an area of the item page 40 that is enclosed in the dotted line is displayed on the display unit 25. The user scrolls the item page 40 by operating the operating unit 24 so as to move the area within the dotted line. The area within the dotted line may be moved up, down, leftward, and rightward, and may be changeable in size.

The online shopping system 1 of this modification example includes the display determining unit 90. The display determining unit 90 determines whether or not a portion of the item page 40 that shows an item for which an arrival notice request has been made has been displayed on the display unit 25 of the user's terminal.

A “portion that shows an item for which an arrival notice request has been made” is an area that displays information about the item for which the user has made an arrival notice request out of the plurality of items included in the item page 40. For example, an area that displays at least one of the basic information 42 and in-stock count 44 of the item for which the user has made an arrival notice request, the input form 46, the purchase button 48, the message 50, and the arrival notice request button 52 corresponds to a portion that shows the item for which an arrival notice request has been made (hereinafter simply referred to as item portion).

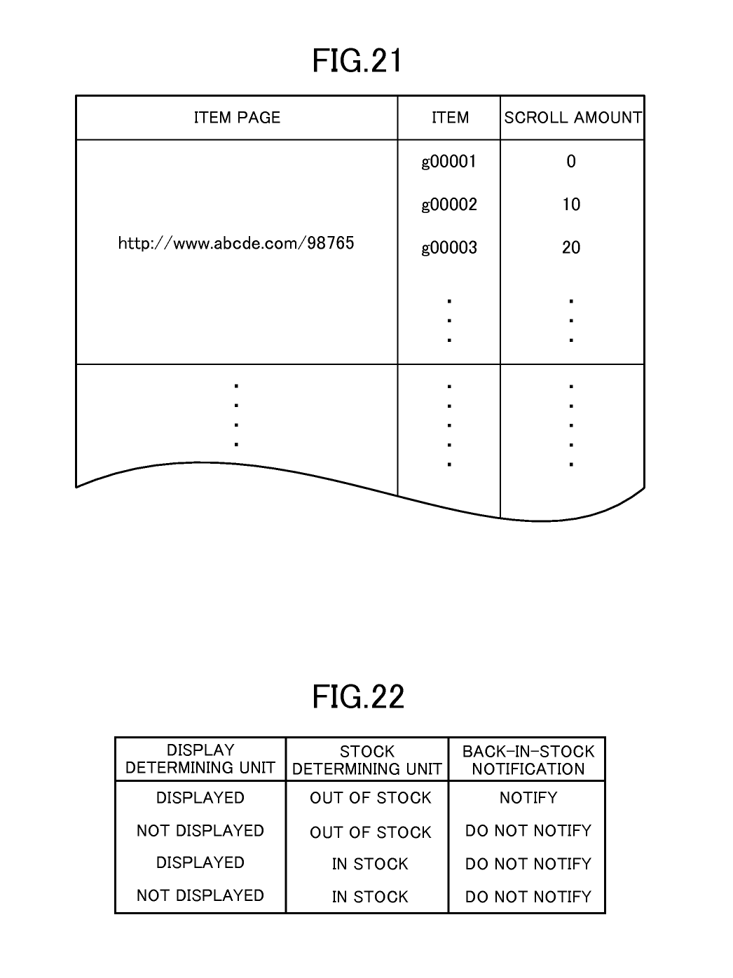

FIG. 21 is a table showing an example of information for identifying the item portion. This information is determined in advance to suit the layout of the item page 40, and is stored in the data storing unit 70. As shown in FIG. 21, for each item, the item and position information about the position of the item portion in the item page 40 are stored in association with each other. Described here is a case where, for each item portion, a scroll amount (for example, a scroll amount measured from the top of the item page 40) necessary to display the item portion is determined as the position information.

The display determining unit 90 determines whether or not the item portion relevant to the arrival notice request has been displayed based on the result of the user's operation and the association described above. For instance, the display determining unit 90 obtains an amount by which the user has scrolled the item page 40 based on what is detected by the operating unit 24, and determines whether or not the scrolling has reached the item portion relevant to the arrival notice request. The scroll amount can be obtained by various known methods. For instance, the processing of obtaining the scroll amount of the item page 40 may be implemented by the JavaScript (trademark).

FIG. 22 is a table that is referred to in a description of the specifics of control exerted by the back-in-stock notification control unit 80 in Modification Example (3). The back-in-stock notification control unit 80 of Modification Example (3) controls a back-in-stock notification based on the result of the determination by the display determining unit 90 and the result of the determination by the stock determining unit 78.

As shown in FIG. 22, in the case where the display determining unit 90 determines that the item portion has been displayed and the stock determining unit 78 determines that the item is out of stock, for example, the back-in-stock notification control unit 80 exerts control so as to notify the user in the future that the item is back in stock. In this case, because the item is out of stock at the time of access to the item page 40 and the item portion relevant to the arrival notice request has been displayed as well, the back-in-stock notification control unit 80 deems that the user is highly interested in the item and that the need to send a back-in-stock notice mail is high, and sets the arrival notification flag to “1”.

On the other hand, when the display determining unit 90 determines that the item portion has not been displayed and the stock determining unit 78 determines that the item is out of stock, for example, the back-in-stock notification control unit 80 exerts control so that the user is not notified in the future that the item is back in stock. In this case, because the item is out of stock at the time of access to the item page 40 and the item portion relevant to the arrival notice request is not displayed in the first place, the back-in-stock notification control unit 80 deems that the user has lost interest in the item and that the need to send a back-in-stock notice mail is low, and sets the arrival notification flag to “0”.

As shown in FIG. 22, in the case where the stock determining unit 78 determines that the item is in stock, the back-in-stock notification control unit 80 deems the need to send a back-in-stock notice mail as low irrespective of the result of the determination by the display determining unit 90, and sets the arrival notification flag to “0”. This is because, with the item in stock, the user is likely to purchase the item in subsequent access although the item portion relevant to the arrival notice request has not been displayed.

According to Modification Example (3), whether or not an item portion relevant to an arrival notice request has been displayed can be used as a condition for controlling a back-in-stock notification. For instance, when a user has not performed an operation of displaying an item portion relevant to an arrival notice request, the user may have lost interest in the item and transmitting an unnecessary back-in-stock notice mail to the user can be prevented.

(4) For example, the item page 40 may be configured so as to allow a user to check, on the item page 40, that arrival notification settings are in effect by disabling the arrival notice request button 52 so that the arrival notice request button 52 cannot be selected in the case where the user accesses the item page 40 with the arrival notification flag set to “1”.

The online shopping system 1 of this modification example includes the disabling unit 92. The disabling unit 92 disables the selecting of an indicator (e.g., the arrival notice request button 52) on the item page 40 when the user is to be notified in the future that the item is back in stock. The disabling here is to keep the arrival notice request button 52 from being selected, for example, setting the attributes of the button in HTML to “disabled”.

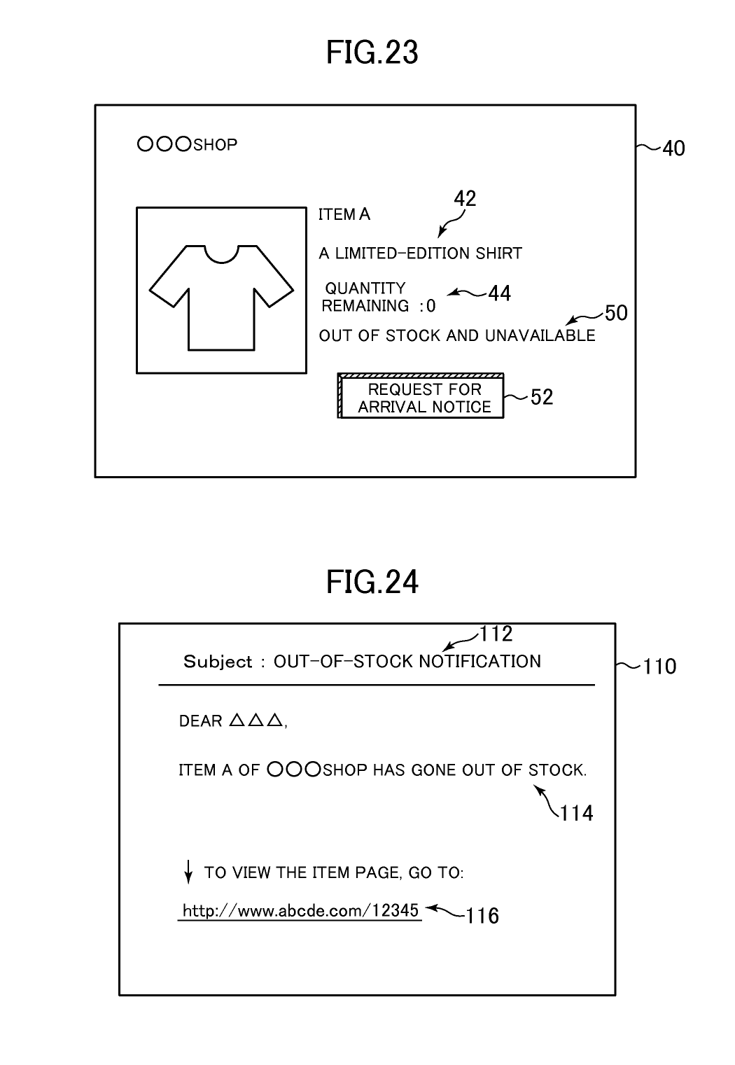

FIG. 23 is a diagram illustrating an example of the item page 40 in Modification Example (4). Here, the display mode of the arrival notice request button 52 that is disabled differs from the display mode of the arrival notice request button 52 that is abled (FIG. 5) as illustrated in FIG. 23. Whether the arrival notice request button 52 is disabled or not can be checked by checking whether the arrival notice request button 52 is in relief or sunken.

When the arrival notice request button 52 is disabled, for example, the arrival notice request button 52 is displayed so that the surface of the arrival notice request button 52 seems to the user to be below other areas of the item page 40. When the arrival notice request button 52 is enabled, on the other hand, the arrival notice request button 52 is displayed so that the surface of the arrival notice request button 52 seems to the user to be above other areas of the item page 40. In FIG. 23 where the arrival notice request button 52 has already been selected, the user is restricted (prevented) from making an arrival notice request.

According to Modification Example (4), a user can easily check on the item page 40 that arrival notification settings are in effect by disabling the arrival notice request button 52.

The method of expressing that an indicator is disabled is not limited to the example of FIG. 23. Any method suitable for identifying whether a particular image used as an indicator is enabled or disabled can be employed. For example, in the case where a radio button is used as an indicator for making an arrival notice request, that the indicator is disabled may be expressed by hiding the radio button itself from the screen.

(5) For example, a user who has made an arrival notice request may be prevented from accessing the item page 40 of an out-of-stock item by transmitting an out-of-stock notice to the user when the item for which the user has made the arrival notice request has gone out of stock again.

The online shopping system 1 of this modification example includes the out-of-stock notifying unit 94 and the access determining unit 96. The out-of-stock notifying unit 94 notifies a user that an item is out of stock when the item arrives and then goes out of stock again. An out-of-stock notice is a message informing that an item has gone out of stock again, or an image indicating that an item has gone out of stock again. The out-of-stock notifying unit 94 notifies a user who has made an arrival notice request that the item is out of stock. Described here is a case where e-mail is transmitted as an out-of-stock notice. The e-mail is hereinafter simply referred to as out-of-stock notice mail.

FIG. 24 is a diagram illustrating an example of the out-of-stock notice mail. As illustrated in FIG. 24, the out-of-stock notice mail which is denoted by 110 includes a subject 112 and a message 114 which indicate that the item has gone out of stock again, and a link 116 to the item page 40. Data (e.g. a template) about the out-of-stock notice mail 110 is stored in the data storing unit 70 in advance.

In the case where an item of a shop goes out of stock, for example, the out-of-stock notifying unit 94 refers to the arrival notification data to identify a user who has requested for an arrival notice of the item. Specifically, the out-of-stock notifying unit 94 refers to a user ID in a record where the shop ID of the shop and the item ID of the item are stored. The out-of-stock notifying unit 94 transmits the out-of-stock notice mail 110 to the identified user.

The out-of-stock notifying unit 94 may notify the user that an item is out of stock in the case where the user does not access the item page 40 during a period from the notification of the arrival to the item's going out of stock again. In other words, in the case where the user accesses the item page 40 during this period, the out-of-stock notifying unit 94 may not notify the user that the item is out of stock on the account that the user has checked the in-stock count of the item. The out-of-stock notifying unit 94 refers to a transmission time in the arrival notification data and an access history in the user data to determine whether or not the user has accessed the item page 40 during the period from the notification of the arrival to the item's going out of stock again.

The access determining unit 96 determines whether or not the user has accessed the item page 40 in response to the out-of-stock notice.

The access determining unit 96 determines, for example, whether or not the user has accessed the item page 40 by selecting the link 116 of the out-of-stock notice mail 110. The access determining unit 96 in this case determines whether or not the user has accessed the item page 40 by selecting the link 116 by determining whether or not given arguments have been received when the user accessed the item page 40. The arguments are included in the link 116.

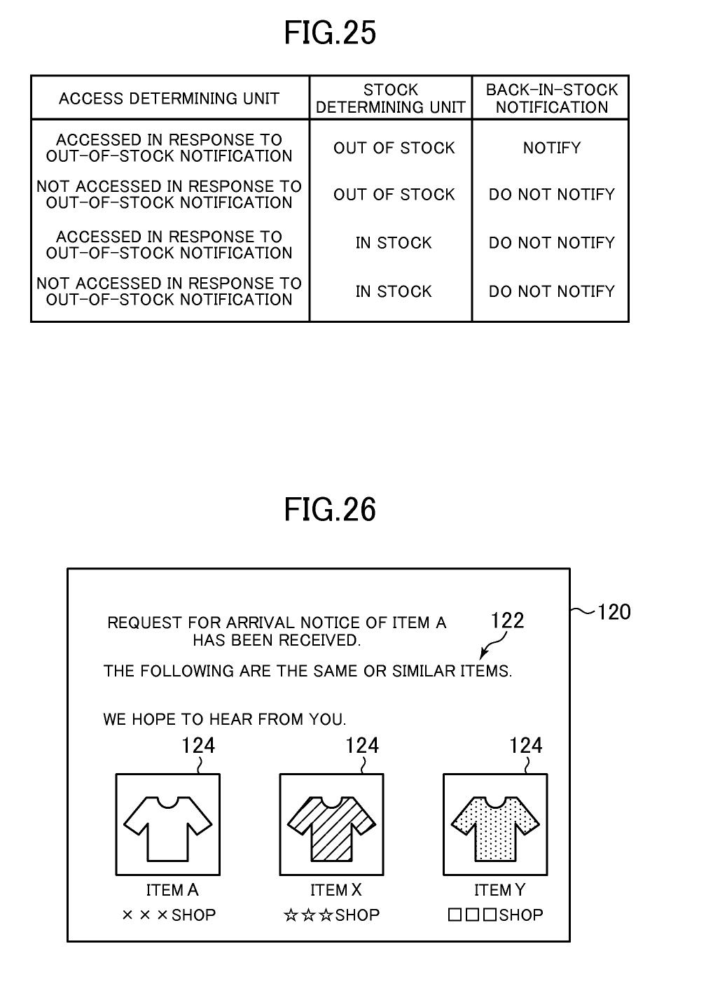

FIG. 25 is a table that is referred to in a description of the specifics of control exerted by the back-in-stock notification control unit 80 in Modification Example (5). The back-in-stock notification control unit 80 of Modification Example (5) controls a back-in-stock notification based on the result of the determination by the access determining unit 96 and the result of the determination by the stock determining unit 78.

As shown in FIG. 25, in the case where the access determining unit 96 determines that access has been made in response to an out-of-stock notice and the stock determining unit 78 determines that the item is out of stock, for example, the back-in-stock notification control unit 80 exerts control so as to notify the user in the future that the item is back in stock. In this case, because the item is out of stock at the time of access to the item page 40 and the access has been made in response to an out-of-stock notice as well, the back-in-stock notification control unit 80 deems that the user is highly interested in the item and that the need to send a back-in-stock notice mail is high, and sets the arrival notification flag to “1”.

On the other hand, when the access determining unit 96 determines that the access has not been made in response to an out-of-stock notice and the stock determining unit 78 determines that the item is out of stock, for example, the back-in-stock notification control unit 80 exerts control so that the user is not notified in the future that the item is back in stock. In this case, because the item is out of stock at the time of access to the item page 40 and the access has not been made in response to an out-of-stock notice, the back-in-stock notification control unit 80 deems that the user has lost interest in the item and that the need to send a back-in-stock notice mail is low, and sets the arrival notification flag to “0”.

As shown in FIG. 25, in the case where the stock determining unit 78 determines that the item is in stock, the back-in-stock notification control unit 80 deems the need to send a back-in-stock notice mail as low irrespective of the result of the determination by the access determining unit 96, and sets the arrival notification flag to “0”. This is because, with the item in stock, the user is likely to proceed to purchase the item.

According to Modification Example (5), whether or not access has been made in response to an out-of-stock notice can be used as a condition for controlling a back-in-stock notification. For example, whether a user's interest in an item is strong or not is estimated by checking whether or not the access has been made in response to an out-of-stock notice so that transmitting a back-in-stock notice mail to a user who has lost interest can be prevented.

The access determining unit 96 may estimate whether or not access has been made in response to an out-of-stock notice by determining whether or not the item page 40 has been accessed after an out-of-stock notice is presented to the user (namely, after the out-of-stock notice mail 110 is opened). The access determining unit 96 in this case determines, for example, whether or not the time when the item page 40 is accessed is later than the time when the out-of-stock notice is presented.

“Presenting” here is to display an out-of-stock notice on the display unit 25 of the user's terminal, for example, to open the out-of-stock notice mail 110. The method of determining whether or not an out-of-stock notice has been presented to the user varies depending on the notification medium (channel) used for out-of-stock notification. For instance, in the case where the user is notified that an item is out of stock by a given message that is displayed on the screen, whether or not the user's viewing history includes the viewing of this screen is determined. Information indicating a viewing history is stored in the user data or the like, and is updated as the need arises so as to reflect the user's access state.

(6) For example, when an arrival notice request is made for an item that is out of stock, the online shopping system 1 may recommend to a user the same item as the out-of-stock item or a second item similar to the out-of-stock item.

The online shopping system 1 of this modification example includes the item suggesting unit 98. When an arrival notice request is received, the item suggesting unit 98 suggest to the user the same item as the one for which the arrival notice request is made or a second item similar to the item of the arrival notice request. Suggesting a second item is leading to the item page 40 of a second item, for example, displaying the item page 40 of a second item or displaying a link (URL) to the item page 40 of a second item. A second item suggested here may be carried by a shop that carries the item of the arrival notice request, or may be carried by a different shop.

A similar item is an item that is the same in attributes (properties), for example, an item belonging to the same item category. Here, the data storing unit 70 stores in advance data that indicates association between one item and the same item as the one item or a second item similar to the one item. The item suggesting unit 98 suggests to the user a second item that is associated with the item of the arrival notice request.

Described here is a case where a second item is suggested on a confirmation screen which indicates that an arrival notice request made by a user has been received.

FIG. 26 is a diagram illustrating an example of the confirmation screen which is displayed on the display unit 25. As illustrated in FIG. 26, the confirmation screen which is denoted by 120 includes a message 122 for informing that an arrival notice request has been received, and a suggestion image 124 of the same item as the item of the arrival notice request or a second item similar to the item of the arrival notice request. The suggestion image 124 includes a link to the item page 40 for purchasing a second item.

According to Modification Example (6), when a user makes an arrival notice request, the same item as the one for which the arrival notice request is made or a second item similar to the item of the arrival notice request can be recommended to the user.

In the case where an item for which an arrival notice request is made has a plurality of items that are the same as or similar to the item of the arrival notice request, the item suggesting unit 98 may suggest to the user one of the plurality of items that is advantageous in purchase conditions over the item of the arrival notice request. The advantageous purchase conditions include at least one of being in stock, a low price, a low shipping fee, taking no time to ship, and providing shopping rewards (for example, giving a lot of points).

Data that indicates purchase conditions for each item is stored in the data storing unit 70. The item suggesting unit 98 identifies an item to be presented to the user by comparing the purchase conditions of the item of the arrival notice request with the purchase conditions of the same item as the item of the arrival notice request or a second item similar to the item of the arrival notice request.

(7) For example, the online shopping system 1 may recommend a user to cancel an arrival notice request when suggesting an item that is the same as the item of the arrival notice request or a second item similar to the item of the arrival notice request.

The online shopping system 1 of this modification example includes the cancellation suggesting unit 100. When the item suggesting unit 98 suggests a second item, the cancellation suggesting unit 100 suggests cancellation of the arrival notice request to the user. Suggesting the cancellation of the arrival notification is to suggest performing an operation for withdrawing an arrival notice request to the user. Withdrawing the arrival notice request is suggested, for example, on the item page 40 of a second item suggested to the user.

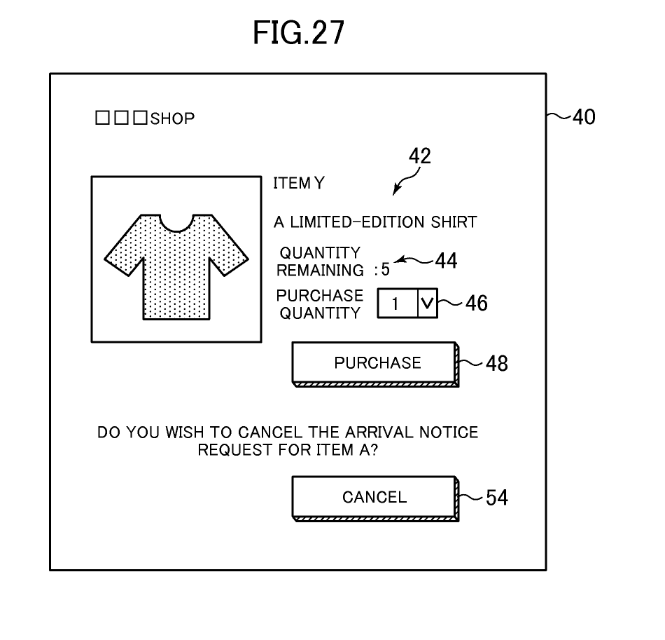

FIG. 27 is a diagram illustrating a screen example of the item page 40 in Modification Example (7). As illustrated in FIG. 27, the item page 40 displays a cancel button 54. When a user selects the cancel button 54, a record for the user is deleted from the arrival notification data, or the arrival notification flag of the user is changed to “0”, thereby completing the withdrawal of the arrival notice request.

According to Modification Example (7), the online shopping system 1 can recommend a user to cancel an arrival notice request when suggesting an item that is the same as the item of the arrival notice request or a second item similar to the item of the arrival notice request.

The method of suggesting the withdrawal of an arrival notice request to a user is not limited to the example given above. For instance, the withdrawal of an arrival notice request may be suggested on the confirmation screen 120. To give another example, the withdrawal of an arrival notice request may be suggested by transmitting a given message to the user. In this case, a record for the user is deleted from the arrival notification data when the user selects a link or the like included in the message and accesses a given page.

(8) Another example is described. While it is determined in the embodiments that an item is in stock when even a piece of the item is still in stock, a user who purchases an item in bulk may not purchase an item unless the count of in-stock pieces of the item is equal to or more than a desired count. For example, a user who wishes to purchase twenty pieces of an item may not purchase the item even when the count of in-stock pieces of the item changes from 0 to 10, and purchase only when the in-stock count of the item reaches twenty or higher. Accordingly, a back-in-stock notice mail may be transmitted to the user after the item is arrived until the in-stock count of the item reaches twenty or higher.

The online shopping system 1 of Modification Example (8) includes the reference count obtaining unit 102. The reference count obtaining unit 102 obtains a specified count of pieces of an item which is specifiedby a user (namely, a reference count). For example, when selecting the arrival notice request button 52, the user inputs a count of pieces of the item. The reference count obtaining unit 102 obtains the numerical value input by the user from the operating unit 24 of the user terminal 20, thereby obtaining a reference count that is specified by the user. The numerical value specified here is the count of pieces of the item that the user wishes to purchase, and can be said as a count that serves as a condition for notifying the arrival.

The reference count obtaining unit 102 stores the obtained count of pieces of the item in, for example, the arrival notification data. Specifically, a specified count of pieces of an item specified by a user is stored in each record of the arrival notification data.

In the case where the user selects the arrival notice request button 52 without specifying a count of pieces of the item, “0” may be stored as the itempiece count. In this case, the arrival is notified when the in-stock count changes from “0” to 1 or higher.

The stock determining unit 78 of Modification Example (8) determines whether or not an item is in stock based on the current in-stock count of the item and the user's specified count. For example, the stock determining unit 78 determines whether or not the in-stock count of the item is equal to or more than the user's specified count. In other words, the stock determining unit 78 determines whether or not the item is in stock by determining whether or not the in-stock count is equal to or more than a count specified by the user who has made the arrival notice request.

According to Modification Example (8), the count of in-stock pieces of an item based on which whether to notify a user that the item has arrived or that the item is back in stock can be varied to suit the user.

(9) Still another example is described. While a case of automatically changing the value of the arrival notification flag has been described above as an example of control for sending a back-in-stock notice mail and control for not sending a back-in-stock notice mail, other methods may be used to perform control for sending a back-in-stock notice mail and control for not sending a back-in-stock notice mail.

For instance, a confirmation dialogue for letting a user select whether or not sending a back-in-stock notice mail is necessary may be displayed when the user accesses the item page 40. The processing of displaying the confirmation dialogue is implemented by, for example, the JavaScript (trademark). The confirmation dialogue displays, for example, a button that allows the online shopping system 1 to send a back-in-stock notice mail and a button that prohibits the online shopping system 1 from sending a back-in-stock notice mail. The online shopping system 1 may be configured so that the arrival notification flag is set to “1” when the button for sending a back-in-stock notice mail is selected, whereas the arrival notification flag is set to “0” when the button for not sending a back-in-stock notice mail is selected. In this case, displaying the button for sending a back-in-stock notice mail on the confirmation dialogue corresponds to control for sending a back-in-stock notice mail, and displaying the button for not sending a back-in-stock notice mail on the confirmation dialogue corresponds to control for not sending a back-in-stock notice mail.

While a case of using e-mail as a notification medium of an arrival notice and a back-in-stock notice has been described, the method of notifying an item's arrival or coming back in stock is not limited thereto. Other methods may be used as long as notification of an item's arrival or coming back in stock is displayed on the display unit 25 of the user's terminal. For example, a given message may be displayed at the top of the item page 40 to notify an item's arrival or coming back in stock, or a given message may be displayed at a portal site of a service provider of the online shopping system 1 to notify an item's arrival or coming back in stock. That an item has arrived or has come back in stock may thus be notified by displaying a message on a Web page.

While the description given above takes as an example a case of using an arrival notification flag to identify whether to notify a user that an item has arrived or has come back in stock, other methods may be used to identify whether to notify an item's arrival or coming back in stock. For example, a record (target information) for a user who has been notified of the arrival once may be deleted from the arrival notification data, or may be evacuated to another table. In other words, deleting or evacuating a record for a user who has made an arrival notice request from the arrival notification data may correspond to control for not notifying in the future that the item is back in stock, whereas adding a record for a user who has made an arrival notice request to the arrival notification data may correspond to control for notifying in the future that the item is back in stock.

While a case where inventory data is updated when a user purchases an item or a staff member of a shop performs an item arrival operation has been described, various known methods can be used when it comes to the method of updating the inventory data. For example, in the case where a user is to add items that the user is intending to purchase to a list (i.e., shopping cart) before actually purchasing the items, the inventory data may be updated at the time an item is added to the list.

The online shopping system 1 may also be configured so that a user can withdraw his/her own arrival notice request. For example, in the case where a user has requested for an arrival notice of an item, the arrival notice request button 52 on the item page 40 of this item is already selected, and the arrival notice request may be cancelled by selecting the button once more.

While a case of implementing the function blocks with a single server computer has been described in the embodiments, the functions may be distributed among a plurality of computers that constitute the online shopping system 1. In the case where the online shopping system 1 includes a plurality of servers, different servers may function as, for example, a server for receiving an arrival notice request (namely, a server that implements the arrival notice request receiving server 74) and a server that actually transmits the arrival notice mail 60 (namely, a server that implements the arrival notifying unit 76).

Some functions of the function blocks may be implemented in the user terminal 20. For example, when the confirmation dialogue is displayed by the JavaScript (trademark), the script is executed mainly by the user terminal 20. Accordingly, the user terminal 20 may implement the function of the back-in-stock notification control unit 80 by executing the processing of displaying the confirmation dialogue.

While the description given above deals with an example of applying a notification control system according to the present invention to an online shopping system, the notification control system according to the present invention is applicable to various systems that involve notifying the arrival of a stock. For instance, the notification control system according to the present invention can also be applied to a system in which a user orders an item on an item page and picks up the item at a real store, instead of online shopping.

The invention claimed is:

1. A notification control device, comprising:
an obtaining unit that obtains what is stored in a storage that stores an in-stock count of an item;
an arrival notice request receiving unit that receives a request for an arrival notice of the item including user identification information for identifying a user;
an arrival notifying unit that notifies, in a case where the in-stock count of the item reaches a reference count or higher, arrival of the item to the user whose arrival notice request has been received, based on identification information for identifying whether to notify the user of the arrival of the item;
a stock determining unit that determines whether or not the in-stock count of the item is equal to or more than the reference count in a case where a request to access an item page of the item is received, the access request including the user identification information of the user whose arrival notice request has been received; and
a back-in-stock notification control unit that controls, by setting the identification information, whether to allow the arrival notifying unit to notify that the item is back in stock to the user whose arrival notice request has been received, based on a result of the determination by the stock determining unit.

2. A notification control device, comprising:
an obtaining unit that obtains what is stored in a storage that stores an in-stock count of an item;
an arrival notice request receiving unit that receives a request for an arrival notice of the item including user identification information for identifying a user;
an arrival notifying unit that notifies, in a case where the in-stock count of the item reaches a reference count or higher, arrival of the item to the user whose arrival notice request has been received, based on target information indicating that the user is to be notified of the arrival of the item;
a stock determining unit that determines whether or not the in-stock count of the item is equal to or more than the reference count in a case where a request to access an item page of the item is received, the access request including the user identification information of the user whose arrival notice request has been received; and
a back-in-stock notification control unit that controls, by deleting or evacuating the target information, whether to allow the arrival notifying unit to notify that the item is back in stock to the user whose arrival notice request has been received, based on a result of the determination by the stock determining unit.

3. The notification control device according to claim 1, further comprising:
ra stop request receiving unit that receives from the user a stop request which is a request to stop the arrival notice; and
a request determining unit that determines whether or not the stop request has been received from the user whose arrival notice request has been received,
wherein the arrival notifying unit notifies a back-in-stock notification to the user whose arrival notice request has been received over a period from the reception of the arrival notice request to the reception of the stop request, and
wherein, in a case where it is determined that the in-stock count of the item is equal to or more than the reference count, the back-in-stock notification control unit controls the arrival notifying unit so that the arrival notifying unit is prevented from notifying that the item is back in stock to the user whose arrival notice request has been received.

4. The notification control device according to claim 1, further comprising:
purchase determining unit that determines whether or not the user whose arrival notice request has been received has purchased the item after the reception of the arrival notice request,
wherein the back-in-stock notification control unit controls a back-in-stock notification to the user whose arrival notice request has been received based on a result of the determination by the purchase determining unit and the result of the determination by the stock determining unit.

5. The notification control device according to claim 1, further comprising:
an interval determining unit that determines whether or not an interval between a time point related to the arrival of the item and a time when the user whose arrival notice request has been received accesses the item page is equal to or more than a reference interval,
wherein the back-in-stock notification control unit controls a back-in-stock notification to the user whose arrival notice request has been received based on a result of the determination by the interval determining unit and the result of the determination by the stock determining unit.

6. The notification control device according to claim 1,
wherein the notification control device further comprises a display determining unit that determines whether or not a portion of the item page that shows an item for which the arrival notice request has been made has been displayed on a display unit corresponding to the user whose arrival notice request has been received, and
wherein the back-in-stock notification control unit controls a back-in-stock notification to the user whose arrival notice request has been received based on a result of the determination by the display determining unit and the result of the determination by the stock determining unit.

7. The notification control device according to claim 1,
wherein the arrival notice request receiving unit receives the arrival notice request in a case where the user whose arrival notice request is received selects a given indicator included in the item page, and
wherein the notification control device further comprises a disabling unit that disables the selecting of the given indicator on the item page in a case where the user whose arrival notice request has been received is to be notified that the item is back in stock.

8. The notification control device according to claim 1, further comprising:
an out-of-stock notifying unit that notifies the user whose arrival notice request has been received that the item is out of stock, based on an inventory of the item; and
an access determining unit that determines whether or not the user whose arrival notice request has been received has accessed the item page in response to the out-of-stock notification,
wherein the back-in-stock notification control unit controls a back-in-stock notification to the user whose arrival notice request has been received based on a result of the determination by the access determining unit and the result of the determination by the stock determining unit.

9. The notification control device according to claim 8, wherein the out-of-stock notifying unit performs the out-of-stock notification in a case where the user whose arrival notice request has been received is yet to access the item page after being notified of the arrival of the item.

10. The notification control device according to claim 1, further comprising an item suggesting unit that suggests, in a case where the arrival notice request is received, the same item as the item for which the arrival notice request is made, or a second item similar to the item of the arrival notice request, to the user whose arrival notice request is received.

11. The notification control device according to claim 10,
wherein the item suggesting unit suggests, to the user whose arrival notice request has been received, one of a plurality of other items that is advantageous in purchase conditions over the item of the arrival notice request.

12. The notification control device according to claim 10, further comprising a cancellation suggesting unit that suggests cancellation of the arrival notice request to the user whose arrival notice request has been received in a case where the item suggesting unit suggests the second item.

13. The notification control unit according to claim 1, further comprising a count obtaining unit that obtains a specified count of pieces of the item, which is specified by the user whose arrival notice request is received,
wherein the stock determining unit performs determining processing based on the current in-stock count of the item and the specified count specified by the user whose arrival notice request is received.

14. (canceled)

15. (canceled)

16. A notification control method, comprising:
obtaining, by a notification control device, what is stored in a storage that stores an in-stock count of an item;
receiving, by the notification control device, a request for an arrival notice of the item including user identification information for identifying a user;
notifying, by the notification control device, in a case where the in-stock count of the item reaches a reference count or higher, arrival of the item to the user whose arrival notice request has been received, based on identification information for identifying whether to notify the user of the arrival of the item;
determining, by the notification control device, whether or not the in-stock count of the item is equal to or more than the reference count in a case where receiving a request to access an item page of the item, the access request including the user identification information of the user whose arrival notice request has been received; and
controlling, by the notification control device, by setting the identification information, whether to notify that the item is back in stock to the user whose arrival notice request has been received, based on a result of the determination.

17. A notification control method, comprising:
obtaining, by a notification control device, what is stored in for a storage that stores an in-stock count of an item;
receiving, by the notification control device, a request for an arrival notice of the item including user identification information for identifying a user;
notifying, by the notification control device, in a case where the in-stock count of the item reaches a reference count or higher, arrival of the item to the user whose arrival notice request has been received, based on target information indicating that the user is to be notified of the arrival of the item;
determining, by the notification control device, whether or not the in-stock count of the item is equal to or more than the reference count in a case where receiving a request to access an item page of the item, the access request including the user identification information of the user whose arrival notice request has been received; and
controlling, by the notification control device, by deleting or evacuating the target information, whether to notify that the item is back in stock to the user whose arrival notice request has been received, based on a result of the determination.

18. (canceled)

19. (canceled)
